(19) United States
(12) Patent Application Publication
(10) Pub. No.: US 2009/0202114 A1
(43) Pub. Date: Aug. 13, 2009

(54) Live-Action Image Capture

(76) Inventors: Sebastien Morin, Castelnau Le Lez (FR); Philippe Vimont, Montpellier (FR)

Correspondence Address: FISH & RICHARDSON PC, P.O. BOX 1022, MINNEAPOLIS, MN, 55440-1022, US

(21) Appl. No.: 12/370,200

(22) Filed: Feb. 12, 2009

Related U.S. Application Data
(60) Provisional application No. 61/028,387, filed on Feb. 13, 2008.

(51) Int. Cl. G06K 9/00

(52) U.S. Cl. 382/118

(57) ABSTRACT

A computer-implemented video capture process includes identifying and tracking a face in a plurality of real-time video frames on a first computing device, generating first face data representative of the identified and tracked face, and transmitting the first face data to a second computing device over a network for display of the face on an avatar body by the second computing device.

### CROSS-REFERENCE TO RELATED APPLICATIONS

This application claims priority to U.S. application Ser. No. 61/028,387, filed on Feb. 13, 2008, and entitled “Live-Action Image Capture,” the contents of which are hereby incorporated in their entirety by reference.

### TECHNICAL FIELD

Various implementations in this document relate generally to providing live-action image or video capture, such as capture of player faces in real time for use in interactive video games.

### BACKGROUND

Video games are exciting. Video games are fun. Video games are at their best when they are immersive. Immersive games are games that pull the player in and make them forget about their ordinary day, about their troubles, about their jobs, and about other problems in the rest of the world. In short, a good video game is like a good movie, and a great video game is like a great movie.

The power of a good video game can come from computing power that can generate exceptional, lifelike graphics. Other great games depend on exceptional storylines and gameplay. Certain innovations can apply across multiple different games and even multiple different styles of games—whether first-person shooter (FPS), role-playing games (RPG), strategy, sports, or others. Such general, universal innovations can, for example, take the form of universal input and output techniques, such as is exemplified by products like the NINTENDO WIIMOTE and its NUNCHUCK controllers.

Webcams—computer-connected live motion capture cameras—are one form of computer input mechanism. Web cams are commonly used for computer videoconferencing and for taking videos to post on the web. Web cams have also been used in some video game applications, such as with the EYE TOY USB camera (www.eyetoy.com).

### SUMMARY

This document describes systems and techniques for providing live action image capture, such as capture of the face of a player of a videogame in real-time. For example, a web cam may be provided with a computer, such as a videogame console or personal computer (PC), to be aimed at a player's face while the player is playing a game. Their face may be located in the field of view of the camera, recognized as being a form that is to be tracked as a face, and tracked as it moves. The area of the face may also be cropped from the rest of the captured video.

The image of the face may be manipulated and then used in a variety of ways. For example, the face may be placed on an avatar or character in a variety of games. As one example, the face may be placed on a character in a team shooting game, so that players can see other players' actual faces and the real time movement of the other players' faces (such as the faces of their teammates). Also, a texture or textures may be applied to the face, such as in the form of camouflage paint for an army game. In addition, animated objects may be associated with the face and its movement, so that, for example, sunglasses or goggles may be placed onto the face of a player in a shooting game. The animated objects may be provided with their own physics attributes so that, for example, hair added to a player may have its roots move with the player's face, and have its ends swing freely in a realistic manner. Textures and underlying meshes that track the shape of a player's face may also be morphed to create malformed renditions of a user's face, such as to accentuate certain features in a humorous manner.

Movement of a user's head (e.g., position and orientation of the face) may also be tracked, such as to change that user's view in a game. Motion of the player's head may be tracked as explained below, and the motion of the character may reflect the motion of the player (e.g., rotating or tilting the head, moving from side-to-side, or moving forward toward the camera or backward away from it). Such motion may occur in a first-person or third-person perspective. From a first-person perspective, the player is looking through the eyes of the character. Thus, for example, turning of the user's head may result in the viewpoint of the player in a first-person game turning. Likewise, if the player stands up so that her head moves toward the top of the captured camera frame, her corresponding character may move his or her head upward. And when a user's face gets larger in the frame (i.e., the user's computer determines that characteristic points on the user's face have become farther apart), a system may determine that the user is moving forward, and may move the associated character forward in turn.

A third-person perspective is how another player may see the player whose image is being captured. For example, if a player in a multi-player game moves his head, other players whose characters are looking at the character or avatar of the first player may see the head moving (and also see the actual face of the first player “painted” onto the character with real-time motion of the player's avatar and of the video of the player's actual face).

In some implementations, a computer-implemented method is disclosed. The method comprises identifying and tracking a face in a plurality of real-time video frames on a first computing device, generating first face data representative of the identified and tracked face, and transmitting the first face data to a second computing device over a network for display of the face on an avatar body by the second computing device. Tracking the face can comprise identifying a position and orientation of the face in successive video frames, and identifying a plurality of salient points on the face and tracking frame-to-frame changes in positions of the salient points. In addition, the method can include identifying changes in spacing between the salient points and recognizing the changes in space as forward or backward movement by the face.

In some aspects, the method can also include generating animated objects and moving the animated objects with tracked motion of the face. The method can also include changing a first-person view displayed by the first computing device based on motion by the face. The first face data can comprise position and orientation data, and can comprise three-dimensional points for a facial mask and image data from the video frames to be combined with the facial mask. In addition, the method can include receiving second face data from the second computing device and displaying with the first computing device video information for the second face data in real time on an avatar body. Moreover, the method can comprise displaying on the first computing device video information for the first face data simultaneously with displaying with the first computing device video information for the second face data. In addition, transmission of face data between the computing devices can be conducted in a peer-to-peer arrangement, and the method can also include receiving from a central server system game status information and displaying the game status information with the first computing device.

In another implementation, a recordable-medium is disclosed. The recordable medium has recorded thereon instructions, which when performed, cause a computing device to perform actions, including identifying and tracking a face in a plurality of real-time video frames on a first computing device, generating first face data representative of the identified and tracked face, and transmitting the first face data to a second computing device over a network for display of the face on an avatar body by the second computing device. Tracking the face can comprise identifying a plurality of salient points on the face and tracking frame-to-frame changes in positions of the salient points. The medium can also include instructions that when executed receive second face data from the second computing device and display with the first computing device video information for the second face data in real time on an avatar body.

In yet another implementation, a computer-implemented video game system is disclosed. The system comprises a web cam connected to a first computing device and positioned to obtain video frame data of a face, a face tracker to locate a first face in the video frame data and track the first face as it moves in successive video frames, and a processor executing a game presentation module to cause generation of video for a second face from a remote computing device in near real time by the first computing device. The face tracker can be programmed to trim the first face from the successive video frames and to block the transmission of non-face video information. Also, the system may further include a codec configured to encode video frame data for the first face for transmission to the remote computing device, and to decode video frame data for the second face received from the remote computing device.

In some aspects, the system also includes a peer-to-peer application manager for routing the video frame data between the first computing device and the remote computing device. The system can further comprise an engine to correlate video data for the first face with a three-dimensional mask associated with the first face, and also a plurality of real-time servers configured to provide game status information to the first computing device and the remote computing device. In some aspects, the game presentation module can receive game status information from a remote coordinating server and generate data for a graphical representation of the game status information for display with the video of the second face.

In another implementation, a computer-implemented video game system is disclosed that includes a web cam positioned to obtain video frame data of a face, and means for tracking the face in successive frames as the face moves and for providing data of the tracked face for use by a remote device.

In yet another implementation, a computer-implemented method is disclosed that includes capturing successive video frames that include images of a moving player face, determining a position and orientation of the face from one or more of the captured video frames, removing non-face video information from the captured video frames, and transmitting information relating to the position and orientation of the face and face-related video information for successive frames in real-time for display on a video game device. The method can also include applying texture over the face-related video information, wherein the texture visually contrasts with the face-related information under the texture. The texture can be translucent or in another form.

In certain aspects, the method also includes generating a display of a make-up color palette and receiving selections from a user to apply portions of the color palette over the face-related video information. The video game device can be a remote video game device, and the method can further include integrating the face-related video information with video frames. In addition, the method can include texture mapping the face-related video information across a three-dimensional animated object across successive video frames, and the animated object can be in a facial area of an avatar in a video game.

In yet other aspects, the method can also include associating one or more animated objects with the face-related video information and moving the animated objects according to the position and orientation of the face. The method can further comprise moving the animated objects according to physics associated with the animated objects. In addition, the method can include applying lighting effects to the animated objects according to lighting observed in the face-related video information, and can also include integrating the face-related video information in a personalized video greeting card. Moreover, the method can comprise moving a viewpoint of a first-person video display in response to changes in the position or orientation of the face.

In another implementation, a computer-implemented method is disclosed, and comprises locating a face of a videogame player in a video image from a web cam, identifying salient points associated with the face, tracking the salient points in successive frames to identify a position and orientation of the face, and using the position and orientation to affect a real-time display associated with a player's facial position and orientation in a video game. The method can further comprise cropping from the video image areas outside an area proximate to the face.

In certain aspects, using the position and orientation to affect a real-time display comprises displaying the face of the first videogame player as a moving three-dimensional image in a proper orientation, to a second videogame player over the internet. In other aspects, using the position and orientation to affect a real-time display comprises changing a first-person view on the videogame player's monitor. In other aspects, using the position and orientation to affect a real-time display comprises inserting the face onto a facial area of a character is a moving video. And in yet other aspects, using the position and orientation to affect a real-time display comprises adding texture over the face and applying the face and texture to a video game avatar.

A computer-implemented video chat method is disclosed in another implementation. The method comprises capturing successive frames of video of a user with a web cam, identifying and tracking a facial area in the successive frames, cropping from the frames of video portions of the frames of video outside the facial area, and transmitting the frames of video to one or more video chat partners of the user.

The details of one or more implementations are set forth in the accompanying drawings and the description below. Other features, objects, and advantages will be apparent from the description and drawings, and from the claims.

### DESCRIPTION OF DRAWINGS

FIG. 1 shows example displays that may be produced by providing real time video capture of face movements in a videogame.

FIG. 2A is a flow chart showing actions for capturing and tracking facial movements in captured video.

FIG. 2B is a flow chart showing actions for locating an object, such as a face, in a video image.

FIG. 2C is a flow chart showing actions for finding salient points in a video image.

FIG. 2D is a flow chart showing actions for applying identifiers to salient points in an image.

FIG. 2E is a flow chart showing actions for posing a mask determined from an image.

FIG. 2F is a flow chart showing actions for tracking salient points is successive frames of a video image.

FIG. 3 is a flow diagram that shows actions in an example process for tracking face movement in real time.

FIGS. 4A and 4B are conceptual system diagrams showing interactions among components in a multi-player gaming system.

FIG. 5A is a schematic diagram of a system for coordinating multiple users with captured video through a central information coordinator service.

FIG. 5B is a schematic diagram of a system for permitting coordinated real time video capture gameplay between players.

FIGS. 6A and 6B are a swim lane diagrams showing interactions of components in an on-line gaming system.

FIGS. 7A-7G show displays from example applications of a live-action video capture system.

FIG. 8 is a block diagram of computing devices that can be used to implement the systems and methods described herein.

Like reference symbols in the various drawings indicate like elements.

### DETAILED DESCRIPTION

The systems and techniques described in this document relate generally to tracking of objects in captured video, such as tracking of faces in video captured by inexpensive computer-connected cameras, known popularly as webcams. Such cameras can include a wide range of structures, such as cameras mounted on or in computer monitor frames, or products like the EYE CAM for the SONY PLAYSTATION 2 console gaming system. The captured video can be used in the context of a videogame to provide additional gameplay elements or to modify existing visual representations. For example, a face of a player in the video frame may be cropped from the video and used and manipulated in various manners.

In some implementations, the captured video can be processed, and information (e.g., one or more faces in the captured video) can be extracted. Regions of interest in the captured face can be classified and used in one or more heuristics that can learn one or more received faces. For example, a set of points corresponding to a region of interest can be modified to reflect substantially similar points with different orientations and light values. These modified regions can be stored with the captured regions and used for future comparisons. In some implementations, once a user has his or her face captured a first time, on successive captures, the user's face may be automatically recognized (e.g., by matching the captured regions of interest to the stored regions of interest). This automatic recognition may be used as a log-in credential. For example, instead of typing a username and password when logging into an online-game, such as a massively multiplayer on-line role-playing game (MMORPG), a user's face may be captured and sent to the log-in server for validation. Once validated, the user may be brought to a character selection screen or another screen that represents that they have successfully logged into the game.

In addition, the captured face (which may be in 2D) may be used to generate a 3D representation (e.g., a mask). The mask may be used to track the movements of the face in real-time. For example, as the captured face rotates, the mask that represents the face may also rotate in a substantially similar manner. In some implementations, the movements of the mask can be used to manipulate an in-game view. For example, as the mask turns, it may trigger an in-game representation of the character's head to turn in a substantially similar manner, so that what the player sees as a first-person representation on their monitor also changes. As another example, as the mask moves toward the camera (e.g., because the user moves their head towards the camera and becomes larger in the frame of the camera), the in-game view may zoom in. Alternatively, if the mask moves away from the camera (e.g., because the user moves their head away from the camera, making their head smaller in the frame of the camera, and making characteristic or salient points on the face move closer to each other), the in-game view may zoom out.

Moreover, the mask can be used to generate a texture from the captured face. For example, instead of mapping a texture from 2D to 3D, the mask can be mapped from 3D to 2D, which can generate a texture of the face (via reverse rendering). In some implementations, the face texture may be applied to other images or other 3D geometries. For example, the face texture can be applied to an image of a monkey which can superimpose the face texture or portions of the face texture) onto the monkey, giving the monkey an appearance substantially similar to the face texture.

In some implementations, the face texture can be mapped to an in-game representation. In such implementations, changes to the face texture may also impact the in-game representation. For example, a user may modify the skin tones of the face texture giving the skin a colored (e.g., greenish appearance). This greenish appearance may modify the in-game representation, giving it a substantially similar greenish hue. As another example, as a user moves muscles in their face (e.g., to smile, talk, wink, stick out their tongue, or generate other facial expressions), the face texture is modified to represent the new facial expression. The face texture can be applied to an in-game representation to reflect this new facial expression.

In some implementations, the facial recognition can be used to ensure that a video chat is child safe. For example, because a face or facial area is found and other elements such as the upper and/lower body can be ignored and cropped out of a video image, pornographic or other inappropriate content can automatically be filtered out in real-time. Various other implementations may include the following:
Make-Up Application: A user may watch a video image of their captured face on a video monitor while a palette of make-up choices is superimposed over the video. The user may select certain choices (e.g., particular colors and make-up types such as lipstick, rouge, etc.) and tools or applicators (e.g., pens, brushes, etc.) and may apply the make-up to their face in the video. As they move (e.g., turning their face to the side or stretching part of their face), they can see how the make-up responds, and can delete or add other forms of make-up. Similar approaches may be taken to applying interactive hair cuts. Also, the user may communicate with another user, such as a professional make-up artist or hair stylist, over the Internet, and the other user may apply the make-up or hair modifications.
Video Karaoke: A user's face may be captured and cropped in real-time and applied over the face of a character in a movie. Portions of the movie character's face may be maintained (e.g., eyebrows) or may be superimposed partially over the user's face (e.g., by making it partially translucent). Appropriate color, lighting, and shading may be applied to the user's face to make it better blend with the video in the movie (e.g., applying a gray texture for someone trying to play the Tin Man, or otherwise permitting a user to apply virtual make-up to their face before playing a character). The user may then observe how well they can provide facial expressions for the movie character.
Video Greeting Cards: In a manner similar to the video karaoke, a player's face may be applied over a character in a moving or static representation to create a moving video presentation. For example, a person may work with their computer so that their face is superimposed on an animal (e.g., with certain levels of fur added to make the face blend with the video or image), a sculpture such as Mount Rushmore (e.g., with a gray texture added to match colors), or to another appropriate item, and the user may then record a personal, humorous greeting, where they are a talking face on the item. Combination of such facial features may be made more subtle by applying a blur (e.g., Guassian) to the character and to the 2D texture of the user's face (with subsequent combination of the “clean” texture and the blurred texture).
Mapping Face Texture to Odd Shapes: Video frames of a user's face may be captured, flattened to a 2D texture, and then stretched across a 3D mask that differs substantially from the shape of the user's face. By this technique, enlarged foreheads and chins may be developed, or faces may be applied to fictional characters having oddly shaped heads and faces. For example, a user's face could be spread across a near-circle so as to be part of a animated flower, with the face taking on a look like that applied by a fish-eye camera lens.
Pretty Video Chat: A user may cover imperfections (e.g., with digital make-Lip) before starting a video chat, and the imperfections may remain hidden even as the user moves his or her face. Also, because the face can be cropped from the video, the user may apply a different head and body around the facial area of their character, e.g., exchanging a clean cut look for a real-life Mohawk, and a suit for a T-shirt, in a video interview with a prospective employer.
Facial Mapping With Lighting: Lighting intensity may be determined for particular areas of a user's face in a video feed, and objects that have been added to the face (e.g., animated hair or glasses/goggles) may be rendered after being subjected to a comparable level of virtual light.
First Person Head Tracking: As explained above and below, tracking of a face may provide position and orientation information for the face. Such information may be associated with particular inputs for a game, such as inputs on the position and orientation of a game character's head. That information may affect the view provided to a player, such as a first-person view. The information may also be used in rendering the user's face in views presented to other players. For instance, the user's head may be shown to the other players as turning side-to-side or tilting, all while video of the user's face is being updated in the views of the other players. In addition, certain facial movements may be used for in-game commands, such as jerking of a head to cock a shotgun or sticking out a tongue to bring up a command menu.
Virtual Hologram: A 3D rendering of a scene may be rendered from the user's perspective, as determined by the position of the user's face in a captured stream of video frames. The user may thus be provided with a hologram-like rendering of the scene-the screen appears to be a real window into a real scene.
Virtual Eye Contact: During video chat, users tend to look at their monitor, and thus not at the camera. They therefore do not make eye contact. A system may have the user stare at the screen or another position once so as to capture an image of the viewer looking at the camera, and the position of the user's head may later be adjusted in real time to make it look like the user is looking at the camera even of they are looking slight above or below it.
Facial Segmentation: Different portions of a person's face may also be captured and then shown in a video in relative positions that differ from their normal positions. For example, a user may make a video greeting card with a talking frog. They may initially assign their mouth to be laid over the frog's mouth and their eyes to match the location of the frog's eyes, after salient points for their face have been captured-even though the frogs eyes may be in the far corners of the frog's face. The mouth and eyes may then be tracked in real time as the user records a greeting.
Live Poker: A player's face may be captured for a game like on-line poker, so that other players can see it and look for “tells.” The player may be given the option of adding virtual sunglasses over the image to mask such tells. Player's faces may also be added over other objects in a game, such as disks on a game board in a video board game.

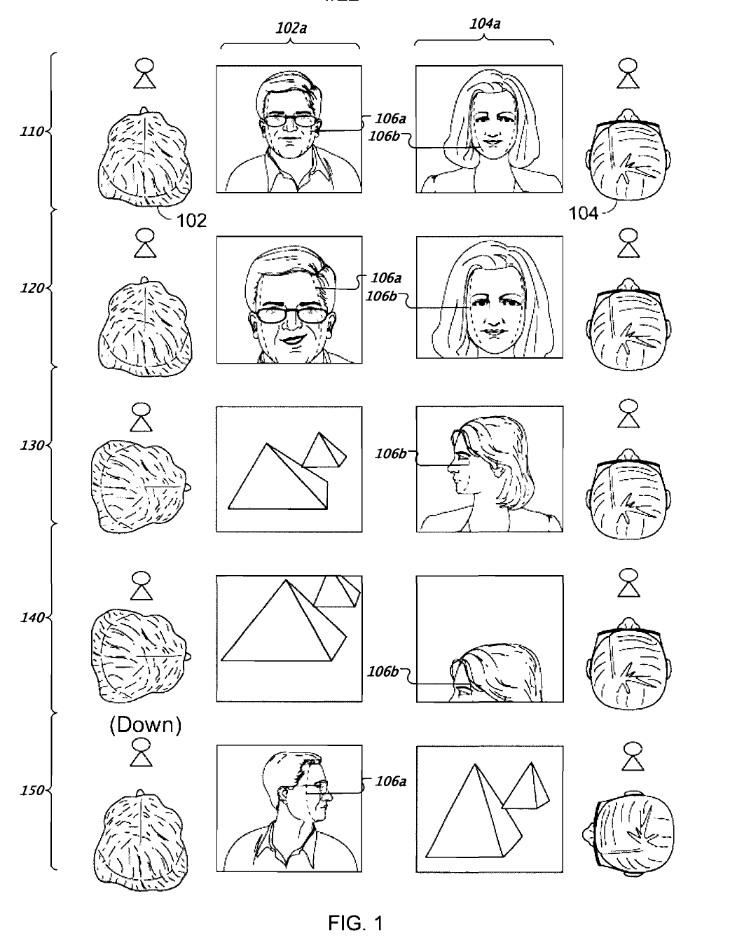

FIG. 1 shows an example display that may be produced by providing real time video capture of face movements in a videogame. In general, the pictured display shows multiple displays over time for two players in a virtual reality game. Each row in the figure represents the status of the players at a particular moment in time. The columns represent, from left to right, (i) an actual view from above the head of a female player in front of a web cam, (ii) a display on the female character's monitor showing her first-person view of the game, (iii) a display on a male character's monitor showing his first-person view of the game, and (iv) an actual view from above the head of the male character in front of a web cam. The particular example here was selected for purposes of simple illustration, and is not meant to be limiting in any mariner.

In the illustrated example, a first-person perspective is shown on each player's monitor. A first-person perspective places an in-game camera in a position that allows the player to view the game environment as if they were looking through the camera, i.e., they see the game as a character in the game sees it. For example, users 102 and 104 can view various scenes illustrated by scenarios 110 through 150 on their respective display devices 102a and 104a, such as LCD video monitors or television monitors. Genres of videogames that employ a first-person perspective include first-person shooters (FPSs), role-playing games (RPGs), and simulation games, to name a few examples.

In the illustrated example, a team-oriented FPS is shown. Initially, the players 102 and 104 may be in a game lobby, chat room, or other non-game environment before the game begins. During this time, they may use the image capture capabilities to socialize, such as engaging in a video-enabled chat. Once the game begins, the players 102 and 104 can view in-game representations of their teammates. For example, as illustrated in scenario 110, player 102 may view an in-game representation of player 104 on her display device 102a and player 104 may view an in-game representation of player 102 on his display device 104a.

In scenarios 110 through 150, the dashed lines 106a and 106b represent delineations between an in-game character model and a face texture. For example, in scenarios 110 through 150, representations inside the dashed lines 106a and 106b may originate from the face texture of the actual player, while representations outside the dashed lines 106a and 106b may originate from a character model, other predefined geometry, or other in-game data (e.g., a particle system, lighting effects, and the like). In some implementations, certain facial features or other real-world occurrences may be incorporated into the in-game representation. For example, the glasses that player 104 is wearing can be seen in-game by player 102 (and bows for the glasses may be added to the character representation where the facial video ends and the character representation begins).

As illustrated by the example scenario 120, players 102 and 104 move closer to their respective cameras (not shown clearly in the view from above each player 102, 104). As the players move, so do a set of tracked points reflected in the captured video image from the cameras. A difference in the tracked points, such as the area encompassed by the tracked points becoming larger or the distance between certain tracked points becoming longer, can be measured and used to modify the in-game camera. For example, the in-game camera's position can change corresponding to the difference in the tracked points. By altering the position of the camera, a zoomed-in view of the respective in-game representations can be presented, to represent that the characters have moved forward in the game model. For example, player 104 views a zoomed-in view of player 102 and player 102 views a zoomed-in view of player 104.

The facial expression of player 104 has also changed in scenario 120, taking on a sort of Phil Donahue-like smirk. Such a presentation illustrates the continual video capture and presentation of player 104 as the game progresses.

In scenario 130, player 102 turns her head to the right. This may cause a change in the orientation of the player's mask. This change in orientation may be used to modify the orientation of the in-game viewpoint. For example, as the head of player 102 rotates to the right, her character's viewpoint also rotates to the right, exposing a different area of the in-game environment. For example, instead of viewing a representation of player 104, player 102 views some mountains that are to her side in the virtual world. In addition, because the view of player 104 has not changed (i.e., player 104 is still looking at player 102), player 104 can view a change in orientation of the head attached to the character that represents player 102 in-game. In other words, the motion of the head of player 102 can be represented in real-time and viewed in-game by player 104. Although not shown, the video frames of both players' faces may also change during this time, and may be reflected, for example, on display 102a of player 102 (e.g., if player 104 changed expressions).

In scenario 140, player 102 moves her head in a substantially downward manner, such as by crouching in front of her webcam. This may cause a downward translation of her mask, for example. As the mask translates in a generally downward manner, the in-game camera view may also change. For example, as the in-game view changes positions to match the movement of player 102, the view of the mountains (or pyramids) that player 102 views changes. For example, the mountains may appear as if player 102 is crouching, kneeling, sitting, ducking, or other poses that may move the camera in a substantially similar manner. (The perspective may change more for items close to the player (e.g., items the player is crouching behind) than for items, like mountains, that are further from the player.) Moreover, because player 104 is looking in the direction of player 102, the view of player 104 changes in the in-game representation of player 102. For example, player 102 may appear to player 104 in-game as crouching, kneeling, sitting, ducking, or other substantially similar poses.

If player 104 were to look down, player 104 might see the body of the character for player 102 in such a crouching, kneeling, or sitting position (even player 102 made their head move down by doing something else). In other words, the system, in addition to changing the position of the face and surrounding head, may also interpret the motion as resulting from a particular motion by the character and may reflect such actions in the in-game representation of the character.

In scenario 150, player 104 turns his head to the left. This may cause a change in the orientation of the mask. This change in orientation may be used to modify the orientation of the in game view for the player 104. For example, as the head of player 104 rotates to the left, the position and orientation of his mask is captured, and his viewpoint in the game then rotates to the left, exposing a different area of the in-game environment (e.g., the same mountains that player 102 viewed in previous scenarios 130, 140). In addition, because player 102 is now looking back towards the camera (i.e., player 102 has re-centered her in-game camera view), player 102 is looking at player 104. As such, player 102 can view a change in the orientation of the head attached to the character that represents player 104 in-game. In other words, the motion of the head of player 104 can also be represented in real-time and viewed in-game play player 102.

In some implementations, the movement of the mask may be amplified or exaggerated by the in-game view. For example, turning slightly may cause a large rotation in the in-game view. This may allow a player to maintain eye contact with the display device and still manipulate the camera in a meaningful way (i.e., they don't have to turn all the way away form their monitor to turn their player's head). Different rates of change in the position or orientation of a player's head or face may also be monitored and used in various particular manners. For example, a quick rotation of the head may be an indicator that the player was startled, and may cause a game to activate a particular weapon held by the player. Likewise, a quick cocking of the head to one side followed by a return to its vertical position may serve as an indication to a game, such as that a player wants to cock a shotgun or perform another function. In this manner, a user's head or facial motions may be used to generate commands in a game.

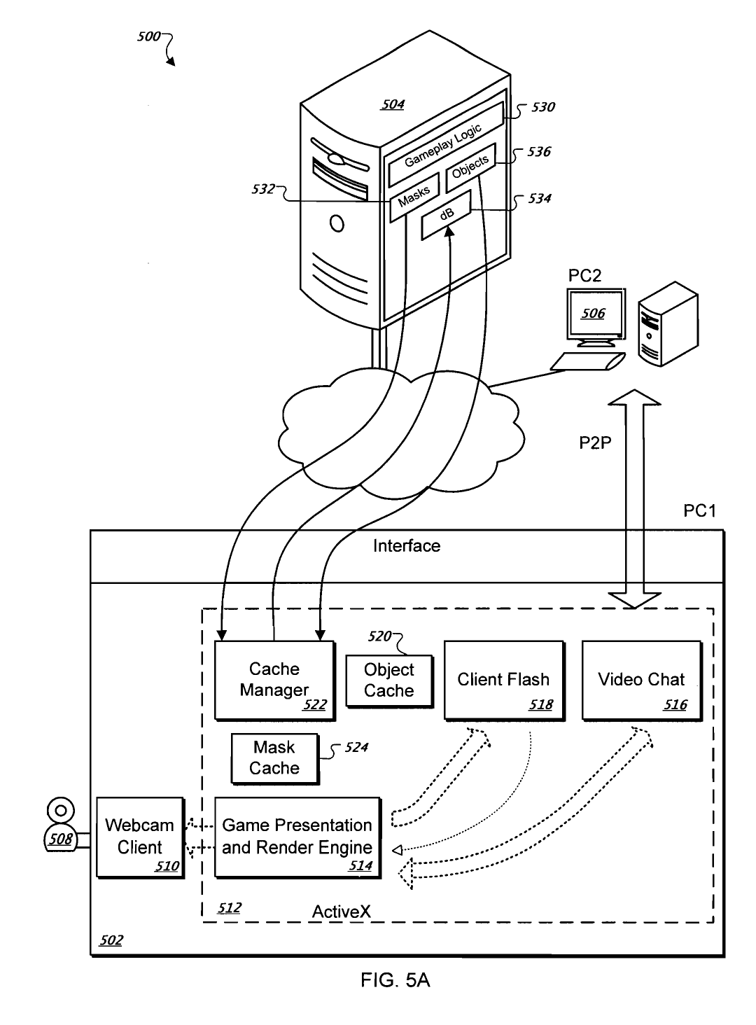

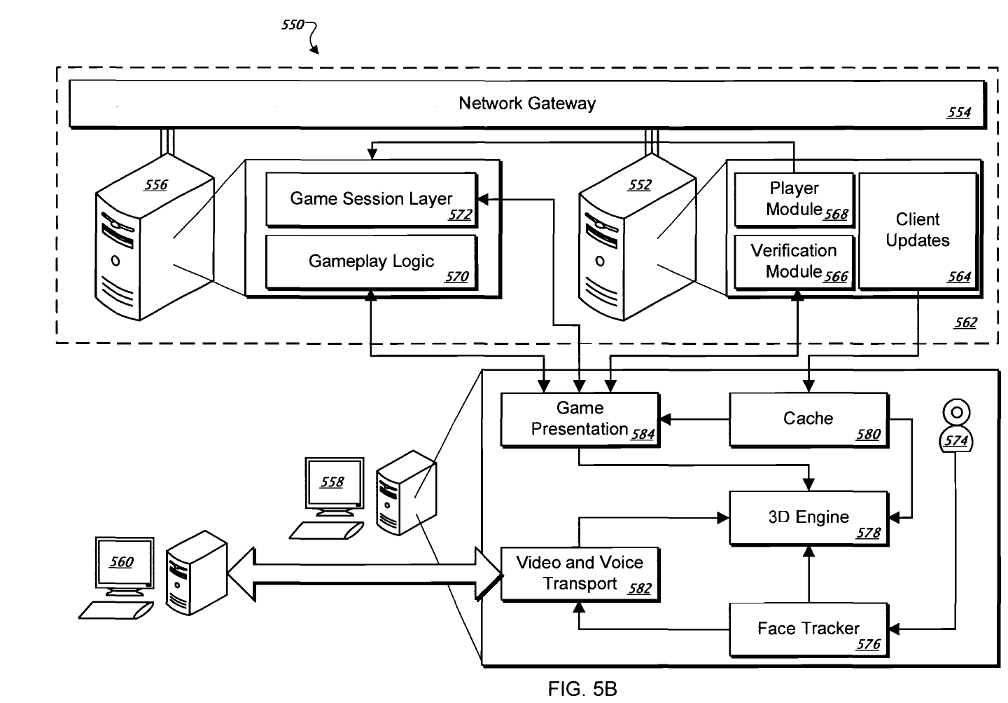

The illustrated representations may be transmitted over a network (e.g., a local area network (LAN), wide area network (WAN), or the Internet). In some implementations, the representations may be transmitted to a server that can relay the information to the respective client system. Server-client interactions are described in more detail in reference to FIGS. 5A and 5B. In some implementations, the representations may be transmitted in a peer-to-peer manner. For example, the game may coordinate the exchange of network identification (e.g., a media access control (MAC) address or an internet protocol (IP) address). When players are within a predetermined distance (e.g., within the camera view distance), updates to a character's representation may be exchanged by generating network packets and transmitting them to machines corresponding to their respective network identifier.

In some implementations, a third-party information provider or network portal may also be used. Examples include, but are not limited to, Xbox Live® from Microsoft (Redmond, Wash.), the Playstation® Network from Sony (Tokyo, Japan), and the Nintendo Wi-Fi Connection Service from Nintendo (Kyoto, Japan). In such implementations, the third-party information provider can facilitate connections between peers by aiding with and/or negotiating a connection between one or more devices connected to the third-party information provider. For example, the third-party information provider may initiate a network handshake between one or more client systems. As another example, if servers of the third-party information provider are queried, the third-party information provider may provide information relating to establishing a network connection with a particular client. For example, the third-party information provider may divulge an open network socket, a MAC address, an IP address, or other network identifier to a client that requests the information. Once a connection is established, the in-game updates can be handled by the respective clients. In some implementations, this may be accomplished by using the established network connections which may by-pass the third-party information providers, for example. Peer-to-peer interactions with and without third party information providers are described in more detail in reference to FIG. 5B and in other areas below.

In some implementations, a videogame can employ a different camera angle or allow multiple in-game camera angles. For example, a videogame may use an isometric (e.g., top down, or ¾) view or have multiple cameras that are each individually selectable. As another example, a default camera angle may be a top down view, but as the player zooms in with the in-game view, the view may zoom into a first-person perspective. Because the use of the first-person perspective is pervasive in videogaming, many of the examples contained herein are directed to that paradigm. However, it should be understood that any or all methods and features implemented in a first-person perspective may also be used in other camera configurations. For example, an in-game camera can be manipulated by the movement of the user's head (and corresponding mask) regardless of the camera perspective.

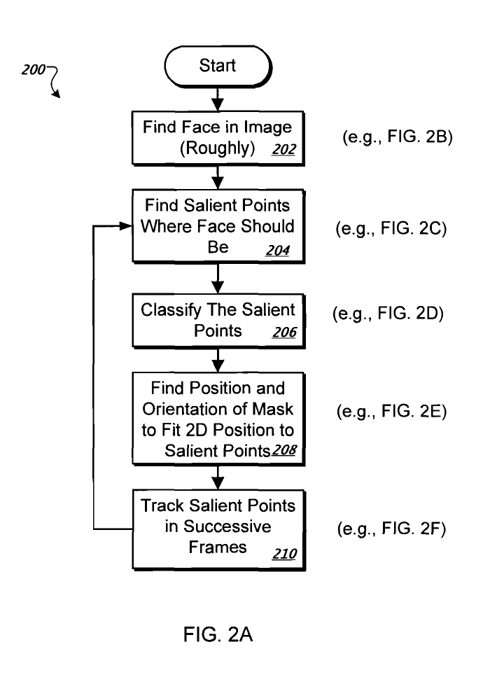

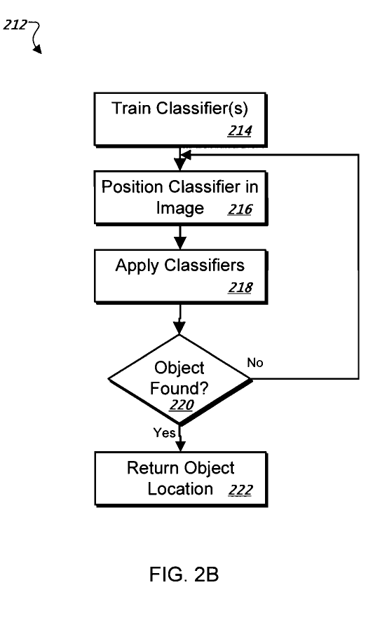

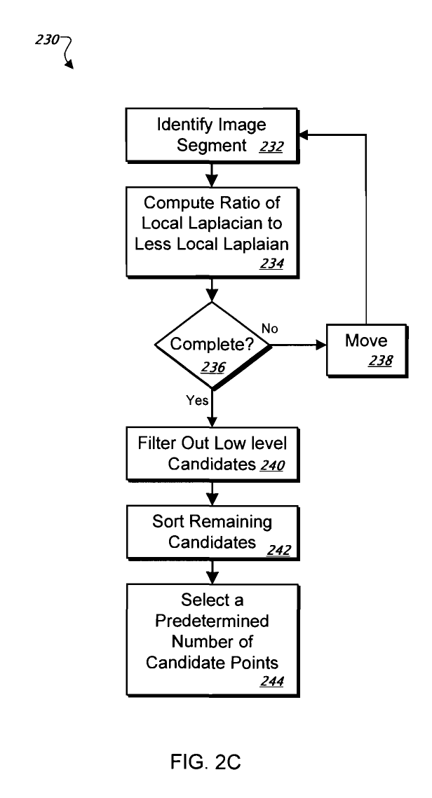

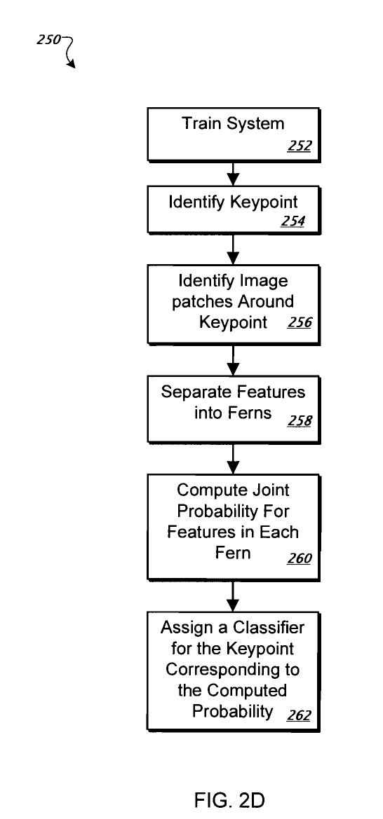

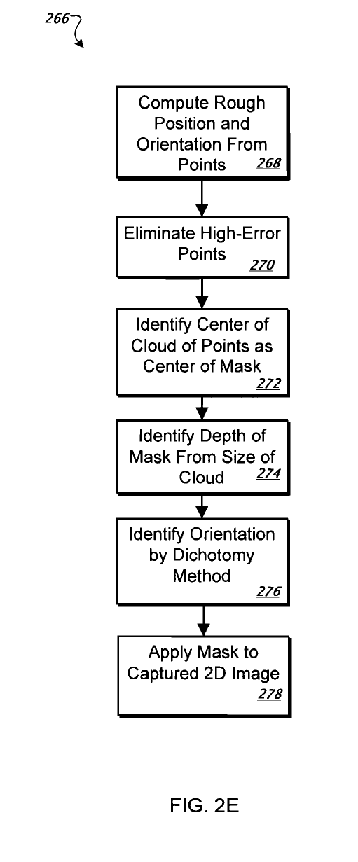

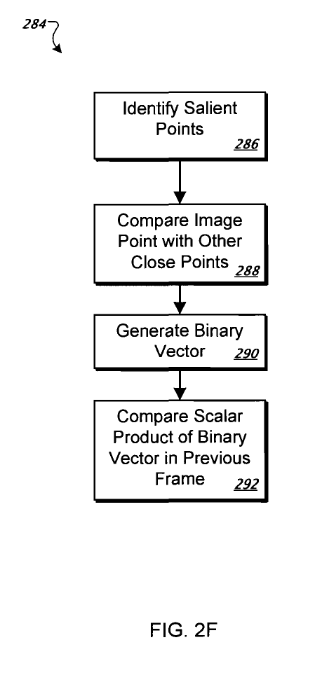

FIGS. 2A-2F are flow charts showing various operations that may be carried out by an example facial capture system. The figures generally show processes by which aspects associated with a person's face in a moving image may be identified and then tracked as the user's head moves. The position of the user's face may then be broadcast, for example, to another computing system, such as another user's computer or to a central server.

Such tracking may involve a number of related components associated with a mask, which is a 3D model of a face rendered by the process. First, position and orientation information about a user's face may be computed, so as to know the position and orientation at which to generate the mask for display on a computer system, such as for a face of an avatar that reflects a player's facial motions and expressions in real time. Also, a user's facial image is extracted via reverse rendering into a texture that may then be laid over a frame of the mask. Moreover, additional accessories may be added to the rendered mask, such as jewelry, hair, or other objects that can have physics applied to them in appropriate circumstances so as to flow naturally with movement of the face or head. Moreover, morphing of the face may occur, such as by stretching or otherwise enhancing the texture of the face, such as by enlarging a player's cheeks, eyes, mouth, chin, or forehead so that the morphed face may be displayed in real time later as the user moves his or her head and changes his or her facial expressions.

In general, FIG. 2A shows actions for capturing and tracking facial movements in captured video. As is known in the art, a video is a collection of sequential image captures, generally known as frames. A captured video can be processed on a frame-by-frame basis by applying the steps of method 200 to each frame of the captured video. Each of the actions in FIG. 2A may be carried out generally; more detailed implementations for each of the actions in FIG. 2A are also shown in FIGS. 2B-2F. The detailed processes may be used to carry out zero, one, or more of the portions of the general process of FIG. 2A.

Referring now to FIG. 2A, a face tracking process 200 generally includes initially finding a face in a captured image. Once found, a series of tests can be performed to determine regions of interest in the captured face. These regions of interest can then be classified and stored. Using the classified regions, a 3D representation (e.g., a mask) can be generated from the regions of interest. The mask can be used, for example, to track changes in position, orientation, and lighting, in successive image captures. The changes in the mask can be used to generate changes to an in-game representation or modify a gameplay element. For example, as the mask rotates, an in-game view can rotate a substantially similar amount. As another example, as the mask translates up or down, an in-game representation of a character's head can move in a substantially similar manner.

In step 202, a face in a captured image frame can be found. In some implementations, one or more faces can be identified by comparing them with faces stored in a face database. If, for example, a face is not identified (e.g., because the captured face is not in the database) the face can be manually identified through user intervention. For example, a user can manipulate a 3D object (e.g., a mask) over a face of interest to identify the face and store it in the face database.

In step 204, salient points in the image area of where the face was located can be found. The salient points are points or areas in an image of a face that may be used to track frame-to-frame motion of the face; by tracking the location of the salient points (and finding the salient points in each image), facial tracking may be simplified. Because each captured image can be different, it is useful to find points that are substantially invariant to rotation, scale, and lighting. For example, consider two images A and B. Both include a face F; however, in image B, face F is smaller and rotated 25 degrees to the left (i.e., the head is rotated 25 degrees to the left). Salient points are roughly at the same position on the face even when it is smaller and rotated by 25 degrees.

In step 206, the salient points that are found in step 204 are classified. Moreover, to preserve the information from image to image, a substantially invariant identification approach can be used. For example, one such approach associates an identifier with a database of images that correspond to substantially similar points. As more points are identified (e.g., by analyzing the faces in different light conditions) the number of substantially similar points can grow in size.

In step 208, a position and orientation corresponding to a mask that can fit the 2D positions of the salient points is determined. In certain implementations, the 2D position of the mask may be found by averaging the 2D positions of the salient points. The z position of the mask can then be determined by the size of the mask (i.e., a smaller mask is more distant than is a larger mask). The mask size can be determined by a number of various mechanisms such as measuring a distance between one set or multiple sets of points, or measuring the area defined by a boundary along multiple points.

In step 210 in FIG. 2A, the salient points are tracked in successive frames of the captured video. For example, a vector can be used to track the magnitude and direction of the change in each salient point. Changes in the tracked points can be used to alter an in-game viewpoint, or modify an in-game representation, to name two examples. For example, the magnitude and direction of one or more vectors can be used to influence the motion of an in-game camera.

FIG. 2B is a flow chart showing actions 212 for locating an object, such as a face, in a video image. In general, a video image may be classified by dividing the image into sub-windows and using one or more feature-based classifiers on the sub-windows. These classifiers can be applied to an image and can return a value that specifies whether an object has been found. In some implementations, one or more classifiers that are applied to a training set of images or captured video images may be determined inadequate and may be discarded or applied with less frequency than other classifiers. For example, the values returned by the classifiers may be compared against one or more error metrics. If the returned value is determined to be outside a predetermined error threshold, it can be discarded. The actions 212 may correspond to the action 202 in FIG. 2A in certain implementations.

The remaining classifiers may be stored and applied to subsequent video images. In other words, as the actions 212 are applied to an image, appropriate classifiers may be learned over time. Because the illustrated actions 212 learn the faces that are identified, the actions 212 can be used to identify and locate faces in an image under different lighting conditions, different orientations, and different scales, to name a few examples. For example, a first instance of a first face is recognized using actions 212, and on subsequent passes of actions 212, other instances of the first face can be identified and located even if there is more or less light than the first instance, if the other instances of the face have been rotated in relation to the first instance, or if the other instances of the first face are larger or smaller than the first instance.

Referring to FIG. 2B, in step 214, one or more classifiers are trained. In some implementations, a large (e.g., 100,000 or more) initial set of classifiers can be used. Classifiers can return a value related to an area of an image. In some implementations, rectangular classifiers are used. The rectangular classifiers can sum pixel values of one or more portions of the image and subtract pixel values of one or more portions of the image to return a feature value. For example, a two-feature rectangular classifier has two adjacent rectangles. Each rectangle sums the pixel values of the pixels they measure, and a difference between these two values is computed to obtain an overall value for the classifier. Other rectangular classifiers include, but are not limited to, a three-feature classifier (e.g., the value of one rectangle is subtracted by the value of the other two adjacent rectangles) and a four-feature classifier (e.g., the value of two adjacent rectangles is subtracted by the value of the other two adjacent rectangles). Moreover, the rectangular classifier may be defined by specifying a size of the classifier and the location in the image where the classifier can be applied.

In some implementations, training may involve applying the one or more classifiers to a suitably large set of images. For example, the set of images can include a number of images that do not contain faces, and a set of images that do contain faces. During training, in some implementations, classifiers can be discarded or ignored that return weighted error values outside a predetermined threshold value. In some implementations, a subset of the classifiers that return the lowest weighted errors can be used after the training is complete. For example, in one implementation, a top 38 classifiers can be used to identify faces in a set of images.

In some implementations, the set of images may be encoded during the training step 214. For example, the pixel values may be replaced with a sum of the previous pixel values (e.g., an encoded pixel value at position (2,2) is equal to the sum of the pixel values of pixels at position (0,0), (0,1), (1,0), (1,1), (1,2), (2,1) and (2,2)). This encoding can allow quick computations because the pixel values for a given area may be defined by the lower right region of a specific area. For example, instead of referencing the pixel values of positions (0,0), (0,1), (1,0), (1,1), (1,2), (2,1) and (2,2), the value can be determined by referencing the encoded pixel value at position (2,2). In certain implementations, each pixel (x, y) of an integral image may be the sum of the pixels in the original image lying in a box defined by the four corners (0, 0), (0, y), (x, 0), and (x, y).

In step 216, one or more classifiers are positioned within a sub-window of the image. Because, in some implementations, the classifiers may include position information, the classifiers may specify their location within the sub-image.

In step 218, the one or more positioned classifiers are applied to the image. In some implementations, the classifiers can be structured in such a way that the number of false positives a classifier identifies is reduced on each successive application of the next classifier. For example, a first classifier can be applied with an appropriate detection rate and a high (e.g., 50%) false-positive rate. If a feature is detected, then a second classifier can be applied with an appropriate detection rate and a lower (e.g., 40%) false-positive rate. Finally, a third classifier can be applied with an appropriate detection rate and an even lower (e.g., 10%) false-positive rate. In the illustrated example, while each false-positive rate for the three classifiers is individually large, using them in combination can reduce the false-positive rate to only 2%.

Each classifier may return a value corresponding to the measured pixel values. These classifier values are compared to a predetermined value. If a classifier value is greater than the predetermined value, a value of true is returned. Otherwise, a value of false is returned. In other words, if true is returned, the classifier has identified a face and if false is returned, the classifier has not identified a face. In step 220, if the value for the entire classifier set is true, the location of the identified object is returned in step 222. Otherwise, if at any point a classifier in the classifier set fails to detect an object when applying classifiers in step 218, a new sub-window is selected, and each of the classifiers in the classifier set is positioned (e.g., step 216) and applied (e.g., step 218) to the new sub-window.

Other implementations than the one described above can be used for identifying one or more faces in an image. Any or all implementations that can determine one or more faces in an image and learn as new faces are identified may be used.

FIG. 2C is a flow chart showing actions 230 for finding salient points in a video image. The actions may correspond to action 204 in FIG. 2A in certain implementations. In general, the process involves identifying points that are substantially invariant to rotation, lighting conditions, and scale, so that those points may be used to track movement of a user's face in a fairly accurate manner. The identification may involve measuring the difference between the points or computing one or more ratios corresponding to the differences between nearby points, to name two examples. In some implementations, certain points may be discarded if their values are not greater than a predetermined value. Moreover, the points may be sorted based on the computations of actions 230.

Referring to FIG. 2C, in step 232, an image segment is identified. In general, the process may have a rough idea of where the face is located and may begin to look for salient points in that segment of the image. The process may effectively place a box around the proposed image segment area and look for salient points.

In some implementations, the image segment may be an entire image, it may be a sub-section of the image, or it may be a pixel in the image. In one implementation, the image segment is substantially similar in size to 400×300 pixels, and 100-200 salient points may be determined for the image. In some implementations, the image segment is encoded using the sum of the previous pixel values (i.e., the approach where a pixel value is replaced with the pixel values of the previous pixels in the image). This may allow for fewer data references when accessing appropriate pixel values which may improve the overall efficiency of actions 230.

In step 234, a ratio is computed on each image's pixel between its Laplacian and a Laplacian with a bigger kernel radius. In some implementations, a Laplacian may be determined by applying a convolution filter to the image area. For example, a local Laplacian may be computed by using the following convolution filter:

$$[ \begin{matrix}- 1 & - 1 & - 1 \\ - 1 & 8 & - 1 \\ - 1 & - 1 & - 1\end{matrix} ] \qquad Equation 1$$

The example convolution filter applies a weight of −1 to each neighboring pixel and a weight of 8 to the selected pixel. For example, a pixel with a value of (255,255,255) in the red-green-blue (RGB) color space has a value of (−255,−255,−255) after a weight of −1 is applied to the pixel value and a value of (2040, 2040, 2040) after a weight of 8 is applied to the pixel value. The weights are added, and a final pixel value can be determined. For example, if the neighboring pixels have substantially similar values as the selected pixel, the Laplacian value approaches 0.

In some implementations, by using Laplacian calculations, high energy points, such as corners or edge extremities, for example, may be found. In some implementations, a large Laplacian absolute value may indicate the existence of an edge or a corner. Moreover, the more a pixel contributes to its Laplacian with a big kernel radius, the more interesting it is, because this point is a peak of energy on an edge, so it may be a corner or the extremity of an edge.

In step 236, if computing local and less local Laplacians and their corresponding ratios is completed over the entire image, then the values can be filtered. Otherwise, in step 238 focus is moved to a next set of pixels and a new image segment is identified (e.g., step 232).

In step 240, low level candidates can be filtered out. For example, points that have ratios above a certain threshold are kept, while points that ratios below a certain threshold may be discarded. By filtering out certain points the likelihood that a remaining unfiltered point is an edge extremity or a corner is increased.

In step 242, the remaining candidate points may be sorted. For example, the points can be sorted in descending order based on the largest absolute local Laplacian values. In other words, the largest absolute Laplacian value is first in the new sorted order, and the smallest absolute Laplacian value is last in the sorted order.

in step 244, a predetermined number of candidate points are selected. The selected points may be used in subsequent steps. For example, the points may be classified and/or used in a 3D mask.

A technique of salient point position computation may take the form of establishing B as an intensity image buffer (i.e., each pixel is the intensity of the original image), and establishing G as a Gaussian blur of B, with a square kernel of radius r, with r˜(radius of B)/50. Also, E may be established as the absolute value of (G-B). An image buffer Bᵢₙₜₑᵣₑₛₜ may be established by the pseudo-code

For each point e of E
let b be the corresponding point in Bᵢₙₜₑᵣₑₛₜ
s1=Σ pixels around e in a radius r, with r˜(radius of B)/50
s2=Σ pixels around e in a radius 2*r

The computation of s1 and s2 can be optimized with the use of the Integral Image of E; if (s1/s2)>threshold, then b=1 else b=0. The process may then identify Blobs in Bᵢₙₜₑᵣₑₛₜ, where a Blob is a set of contiguous “On” pixels in Bᵢₙₜₑᵣₑₛₜ (with an 8 connectivity). For each Blob, bI, in Bᵢₙₜₑᵣₑₛₜ, the center of bI may be considered a salient point.

FIG. 2D is a flow chart showing actions 250 for applying classifiers to salient points in an image. The actions 250 may correspond to action 206 in FIG. 2A in certain implementations. In general, under this example process, the salient points are trained and stored in a statistical tree structure. As additional faces and salient points are encountered, they may be added to the tree structure to improve the classification accuracy, for example. In addition, the statistical tree structure can be pruned by comparing current points in the tree structure to one or more error metrics. In other words, as new points are added other points may be removed if their error is higher than a determined threshold. In some implementations, the threshold is continually calculated as new points are added which may refine the statistical tree structure. Moreover, because each face typically generates a different statistical tree structure, the classified points can be used for facial recognition. In other words, the statistical tree structure generates a face fingerprint of sorts that can be used for facial recognition.

In the figure, in step 252, the point classification system is trained. This may be accomplished by generating a first set of points and randomly assigning them to separate classifications. In some implementations, the first set of points may be re-rendered using affine deformations and/or other rendering techniques to generate new or different (e.g., marginally different or substantially different) patches surrounding the points. For example, the patches surrounding the points can be rotated, scaled, and illuminated in different ways. This can help train the points by providing substantially similar points with different appearances or different patches surrounding the points. In addition, white noise can be added to the training set for additional realism. In some implementations, the results of the training may be stored in a database. Through the training, a probability that a point belongs to a particular classification can be learned.

In step 254, a keypoint is identified (where the keypoint or keypoints may be salient points in certain implementations). In some implementations, the identified keypoint is selected from a sorted list generated in a previous step. In step 256, patches around the selected keypoint are identified. In some implementations, a predetermined radius of neighboring points is included in the patch. In one implementation, more than one patch size is used. For example, a patch size of three pixels and/or a patch size of seven pixels can be used to identify keypoints.

In step 258, the features are separated into one or more ferns. Ferns can be used as a statistical tree structure. Each fern leaf can include a classification identifier and an image database of the point and its corresponding patch.

In step 260, a joint probability for features in each fern is computed. For example, the joint probability can be computed using the number of ferns and the depth of each fern. In one implementation, 50 ferns are used with a depth of 10. Each feature can then be measured against this joint probability.

In step 262, a classifier for the keypoint is assigned. The classifier corresponds to the computed probability. For example, the keypoint can be assigned a classifier based on the fern leaf with the highest probability. In some implementations, features may be added to the ferns. For example, after a feature has been classified it may be added to the ferns. In this way, the ferns learn as more features are classified. In addition, after classification, if features generate errors on subsequent classification attempts, they may be removed. In some implementations, removed features may be replaced with other classified features. This may ensure that the most relevant up-to-date keypoints are used in the classification process.

FIG. 2E is a flow chart showing actions 266 for posing a mask determined from an image. In general, the classified salient points are used to figure out the position and orientation of the mask. In some implementations, points with an error value above a certain threshold are eliminated. The generated mask may be applied to the image. In some implementations, a texture can be extracted from the image using the 3D mask as a rendering target. The actions 266 may correspond to action 208 in FIG. 2A in certain implementations.

Referring to the figure, in step 268, an approximate position and orientation of a mask is computed. For example, because we know which classified salient points lie on the mask, where they lie on the mask, and where they lie on the image, we can use those points to specify an approximation of the position and rotation of the mask. In one implementation, we use the bounding circle of those points to approximate the mask 3D position, and a dichotomy method is applied to find the 3D orientation of the mask. For example, the dichotomy method can start with an orientation of +180 degrees and −180 degrees relative to each axes of the mask and converge on an orientation by selecting the best fit of the points in relation to the mask. The dichotomy method can converge by iterating one or more times and refining the orientation values for each iteration.

In step 270, points within the mask that generate high-error values are eliminated. In some implementations, errors can be calculated by determining the difference between the real 2D position in the image of the classified salient points, and their calculated position using the found orientation and position of the mask. The remaining cloud of points may be used to specify more precisely the center of the mask, the depth of the mask, and the orientation of the mask, to name a few examples.

In step 272, the center of the point cloud is used to determine the center of the mask. In one implementation, the positions of each point in the cloud are averaged to generate the center of the point cloud. For example, the x and y values of the points can be averaged to determine a center located at xₐ, yₐ.

In step 274, a depth of the mask is determined from the size of the point cloud. In one implementation, the relative size of the mask can be used to determine the depth of the mask. For example, a smaller point cloud generates a larger depth value (i.e., the mask is farther away from the camera) and a larger point cloud generates a smaller depth value (i.e., the mask is closer to the camera).

In step 276, the orientation of the mask is given in one embodiment by three angles, with each angle describing the rotation of the mask around one of its canonical axes. A pseudo dichotomy may be used to find those three angles. In one particular example, a 3D pose may be determined for a face or mask that is a 3D mesh of a face model, as follows. The variable Proj may be set as a projection matrix to transform 3D world coordinates in 2D Screen coordinates. The variable M=(R, T) may be the rotation Matrix to transform 3D Mask coordinates in 3D world coordinates, where R is the 3D rotation of the mask, as follows: R=Rotₓ(α)*Rot_{y}(β)*Rot_{z}(γ). In this equation, α, β and γ are the rotation angle around the main axis (x,y,z) of the world. Also, T is the 3D translation vector of the mask: T=(tₓ, t_{y}, t_{z}), where tₓ, t_{y} and t_{z} are the translation on the main axis (x,y,z) of the world.

The salient points may be classified into a set S. Then, for each Salient Point Sᵢ in S, we already know Pᵢ the 3D coordinate of Sᵢ in the Mask coordinate system, and pᵢ the 2D coordinate of Sᵢ in the screen coordinate system. Then, for each Sᵢ, the pose error of the i^{th} point for the Matrix M is eᵢ(M)=(Proj*M*Pᵢ)−pᵢ. The process may then search M, so as to minimize Err(M)=Σei(M). And, Inlier may be the set of inliers points of S, i.e. those used to compute M, while Outlier is the set of outliers points of S, so that S=Inlier U Outlier and Inlier ∩Outlier=Ø.

For the main posing algorithm, the following pseudo-code may be executed:

```
    Inlier = S
    Outlier = Ø
    nᵢₜₑᵣₐₜᵢₒₙ = 0
    M_{best} = (identity, 0)
DO
    COMPUTE T (Tₓ , T_{y} , T_{z}), the translation of the Mask on the main
        axis (x,y,z) of the world
    COMPUTE α, β and γ, the rotation angle of the Mask around the
        main axis (x,y,z) of the world
    M_{best} = Rotₓ(α) * Rot_{y}(β) * Rot_{z}(γ) + T
    FOR EACH Sᵢ IN Inlier
        COMPUTE eᵢ(M_{best})
    σ² = Σ_{(FOR all point in Inlier)} eᵢ(M_{best})² / n², where n = Cardinal (Inlier)
    FOR EACH Si IN Outlier
        IF eᵢ(M_{best}) < σ THEN delete Sᵢ in Outlier, add Sᵢ in Inlier
    FOR EACH Sᵢ IN Inlier
        IF eᵢ(M_{best}) > σ THEN delete Sᵢ in Inlier, add Sᵢ in Outlier
    nᵢₜₑᵣₐₜᵢₒₙ = nᵢₜₑᵣₐₜᵢₒₙ + 1
WHILE σ > Err_{threshold}  AND nᵢₜₑᵣₐₜᵢₒₙ < n_{max iteration}
```

The translation T (Tx, Ty, Tz) of the mask on the main axis (x, y, z) in the world may then be computed as follows:

```
FOR EACH Si IN Inlier
  ci = Proj * Mbest * Pi
  bar_{computed} = BARYCENTER of all ci in Inlier
  bar_{given} = BARYCENTER of all pi in S
  (tₓ, t_{y}) = tr + bar_{computed} − bar_{given}, where tr is a constant 2D
    vector depending on Proj
  r_{computed} = Σ_{(FOR all point in Inlier)} DISTANCE(ci,bar_{given}) / m,
  where m = Cardinal (Inlier)
  r_{given} = Σ_{(FOR all point in S)} DISTANCE(pi,bar_{computed}) / n,
  where n = Cardinal (S)
  t_{z} = k * r_{computed} / r_{given}, where k is a constant depending on Proj
  T = (t_{z} , tₓ , t_{y})
```

The rotation angle of the Mask (α, β and γ) on the main axis (x,y,z) of the world may then be computed as follows:

```
    step = π  is the step angle for the dichotomy
    α = β = γ = 0
    Err_{best} = ∞
DO
    FOR EACH αₛₜₑₚ IN (−step, 0, step)
        FOR EACH βₛₜₑₚ IN (−step, 0, step)
            FOR EACH γₛₜₑₚ IN (−step, 0, step)
            α_{current} = α + αₛₜₑₚ , β_{current} = β + βₛₜₑₚ , γ_{current} = γ + γₛₜₑₚ
            M_{current} = Rotₓ(α_{current}) * Rot_{y}(β_{current}) * Rot_{z}(γ_{current}) + T
            Err = Σ_{(FOR all point in Inlier)} eᵢ(M_{current})
            IF Err < Err_{best} THEN
                α_{best} = α_{current} , β_{best} = β_{current} , γ_{best} = γ_{current}
                Err_{best} = Err
                M_{best} = M_{current}
    α = α_{best} , β = β_{best} , γ = γ_{best}
    step = step / 3
WHILE step > stepₘᵢₙ
```

In step 278, a generated mask is applied to the 2D image. In some implementations, the applied mask may allow a texture to be reverse rendered from the 2D image. Reverse rendering is a process of extracting a user face texture from a video feed so that the texture can be applied on another object or media, such as an avatar, movie character, etc. In traditional texture mapping, a texture with (u, v, w) coordinates is mapped to a 3D object with (x, y, z) coordinates. In reverse rendering, a 3D mask with (x, y, z) coordinates is applied and a texture with (u, v, x) coordinates is generated. In some implementations, this may be accomplished through a series of matrix multiplications. For example, the texture transformation matrix may be defined as the projection matrix of the mask. A texture transformation applies a transformation on the points with texture coordinates (u, v, w) and transforms them into (x, y, z) coordinates. A projection matrix can specify the position and facing of the camera. In other words, by using the projection matrix as the texture transformation matrix, the 2D texture is generated from the current view of the mask. In some implementations, the projection matrix can be generated using a viewport that is centered on the texture and fits the size of the texture.

In some implementations, random sample consensus (RANSAC) and the Jacobi method may be used as alternatives in the above actions 266. RANSAC is a method for eliminating data points by first generating an expected model for the received data points and iteratively selecting a random set of points and comparing it to the model. If the are too many outlying points (e.g., points that fall outside the model) the points are rejected. Otherwise, the points can be use to refine the model. RANSAC may be run iteratively, until a predetermined number of iterations have passed, or until the model converges, to name two examples. The Jacobi method is an iterative approach for solving linear systems (e.g., Ax=b). The Jacobi method seeks to generate a sequence of approximations to a solution that ultimately converge to a final answer. In the Jacobi method, an invertible matrix is constructed with the largest absolute values of the matrix specified in the diagonal elements of the matrix. An initial guess to a solution is submitted, and this guess is refined using error metrics which may modify the matrix until the matrix converges.

FIG. 2F is a flow chart showing actions 284 for tracking salient points in successive frames of a video image. Such tracking may be used to follow the motion of a user's face over time once the face has been located. In general, the salient points are identified and the differences in their position from previous frames are determined. In some implementations, the differences are quantified and applied to an in-game camera or view, or an in-game representation, to name two examples. In some implementations, the salient points may be tracked using ferns, may be tracked without using ferns, or combinations thereof. In other words, some salient points may be tracked with ferns while other salient points may be tracked in other manners. The actions 284 may correspond to the action 210 in FIG. 2A in certain implementations.

In step 286, the salient points are identified. In some implementations, the salient points are classified by ferns. However, because ferns classifications may be computationally expensive, during a real-time tracking some of the salient points may not be classified by ferns as the captured image changes from frame to frame. For example, a series of actions, such as actions 230 may be applied to the captured image to identify new salient points as the mask moves, and because the face has already been recognized by a previous classification using ferns, another classification may be unnecessary. In addition, a face may be initially recognized by a process that differs substantially from a process by which the location and orientation of the face is determined in subsequent frames.

In step 288, the salient points are compared with other close points in the image. In step 290, a binary vector is generated for each salient point. For example, a random comparison may be performed between points in a patch (e.g., a 10×10, 20×20, 30×30, or 40×40) around a salient point, with salient points in a prior frame. Such a comparison provides a Boolean result from which a scalar product may be determined, and from which a determination may be made whether a particular point in a subsequent frame may match a salient point from a prior frame.

In step 292, a scalar product (e.g., a dot product) between the binary vector generated in step 290, and a binary vector generated in a previous frame are computed. So, tracking of a salient point in two consecutive frames may involve finding the salient point in the previous frame which lies in an image neighborhood and has the minimal scalar product using the vector classifier, where the vector classifier uses a binary vector generated by comparing the image point with other points in its image neighborhood, and the error metric used is a dot product.

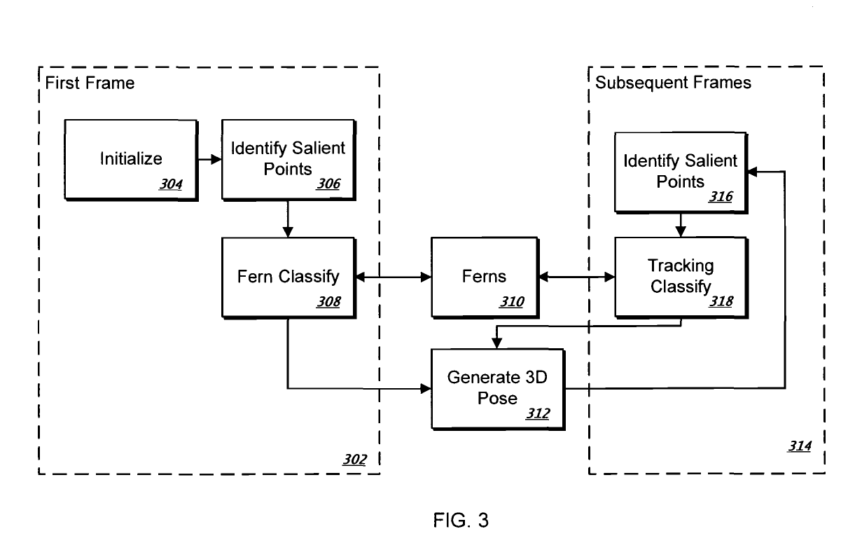

FIG. 3 is a flow diagram that shows actions in an example process for tracking face movement in real time. The process involves, generally, two phases—a first phase for identifying and classifying a first frame (e.g., to find a face), and a second phase of analyzing subsequent frames after a face has been identified. Each phase may access common functions and processes, and may also access its own particular functions and processes. Certain of the processes may be the same as, or similar to, processes discussed above with respect to FIGS. 2A-2F.

In general, the process of FIG. 3 can be initialized in a first frame of a video capture. Then, various salient points can be identified and classified. In some implementations, these classified points can be stored for subsequent operations. Once classified, the points can be used to pose a 3D object, such as a mask or mesh. In subsequent frames, the salient points can be identified and tracked. In some implementations, the stored classification information can be used when tracking salient points in subsequent frames. The tracked points in the subsequent frames can also be used to pose of a 3D object (e.g., alter a current pose, or establish a new pose).

Referring to the figure, in a first frame 302, a process can be initialized in step 304. This initialization may include training activities, such as learning faces, training feature classifiers, or learning variations on facial features, to name a few examples. As another example, the initialization may include memory allocations, device (e.g., webcam) configurations, or launching an application that includes a user interface. In one implementation, the application can be used to learn a face by allowing a user to manually adjust a 3D mask over the captured face in real-time. For example, the user can re-size and reposition the mask so the mask features are aligned with the captured facial features. In some implementations, the initialization can also be used to compare a captured face with a face stored in a database. This can be used for facial verification, or used as other security credentials, to name a few examples. In some implementations, training may occur before a first frame is captured. For example, training feature classifiers for facial recognition can occur prior to a first frame being captured.

In step 306, the salient points are identified. In some implementations, this can be accomplished using one or more convolution filters. The convolution filters may be applied on a per pixel basis to the image. In addition, the filters can be used to detect salient points by finding corners or other edges. In addition, feature based classifiers may be applied to the captured image to help determine salient points.

In step 308, fern classifiers may be used to identify a face and/or facial features. In some implementations, fern classification may use one or more rendering techniques to add additional points to the classification set. In addition, the fern classification may be an iterative process, where on a first iteration ferns are generated in code, and on subsequent iterations, ferns are modify based on various error metrics. Moreover, as the ferns change over time (e.g., growing as shrinking as appropriate) learning can be occurring because the most relevant, least error prone points can be stored in a ferns database 310. In some implementations, the ferns database 310 may be trained during initialization step 304. In other implementations, the ferns database 310 can be trained prior to use.

Once the points have been classified, the points can be used in one or more subsequent frames 314. For example, in step 312, the classified points can be used to generate a 3D pose. The classified points may be represented as a point cloud, which can be used to determine a center, depth, and an orientation for the mask. For example, the depth can be determined by measuring the size of the point cloud, the center can be determined by averaging the x and y coordinates of each point in the point cloud, and the orientation can be determined by a dichotomy method.

In some implementations, a normalization can be applied to the subsequent frames 314 to remove white noise or ambient light, to name two examples. Because the normalization may make the subsequent frames more invariant in relation to the first frame 302, the normalization may allow for easier identification of substantially similar salient points.

In step 318, the points can be tracked and classified. In some implementations, the fern database 310 is accessed during the classification and the differences between the classifications can be measured. For example, a value corresponding to a magnitude and direction of the change can be determined for each of the salient points. These changes in the salient points can be used to generate a new pose for the 3D mask in step 312. In addition, the changes to the 3D pose can be reflected in-game. In some implementations, the in-game changes modify an in-game appearance, or modify a camera position, or both.

This continuous process of identifying salient points, tracking changes in position between subsequent frames, updating a pose of a 3D mask, and modifying in-game gameplay elements or graphical representation related to the changes in the 3D pose may continue indefinitely. Generally, the process outlined in FIG. 3 can be terminated by a user. For example, the user can exit out of a tracker application or exit out of a game.

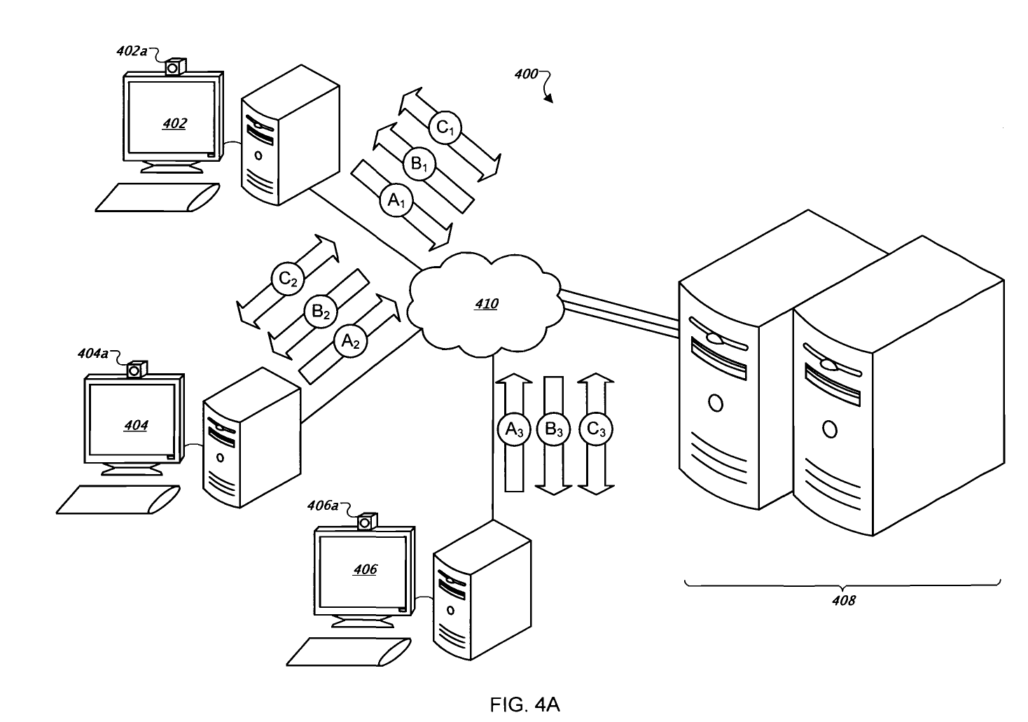

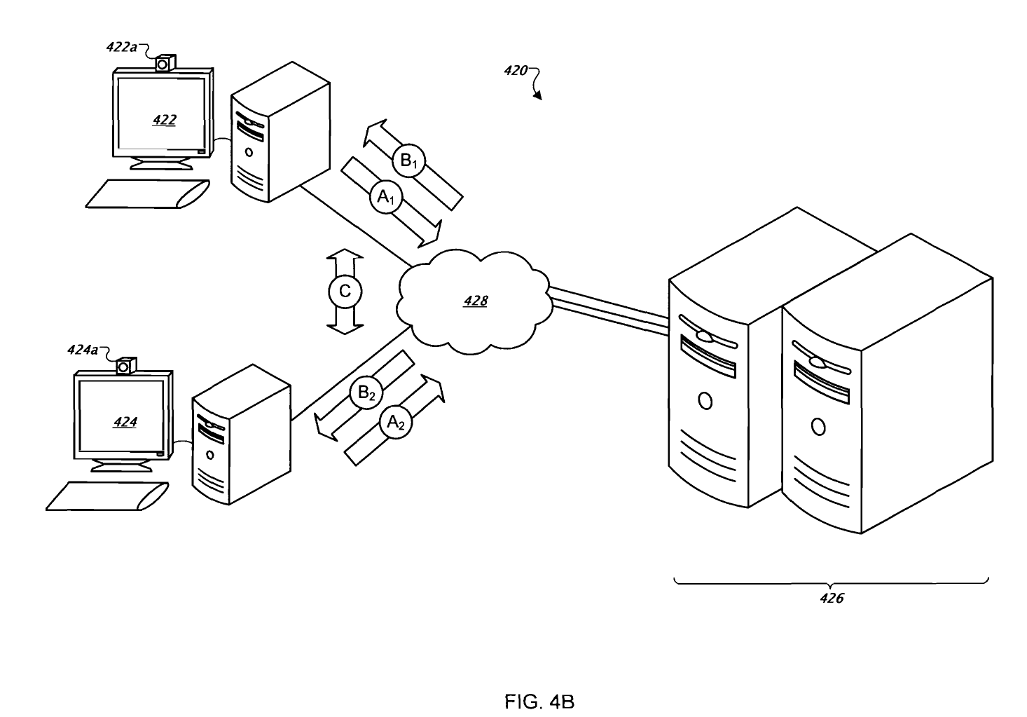

FIG. 4A is a conceptual system diagram 400 showing interactions among components in a multi-player gaming system. The system diagram 400 includes one or more clients (e.g., clients 402, 404, and 406). In some implementations, the clients 402 through 406 communicate using a TCP/IP protocol, or other network communication protocol. In addition, the clients 402 through 406 are connected to cameras 402a through 406a, respectively. The cameras can be used to capture still images, or full motion video, to name two examples. The clients 402 through 406 may be located in different geographical areas. For example, client 402 can be located in the United States, client 404 can be located in South Korea, and client 406 can be located in Great Britain.

The clients 402 through 406 can communicate to one or more server systems 408 through a network 410. The clients 402 through 406 may be connected to the same local area network (LAN), or may communicate through a wide area network (WAN), or the Internet. The server systems 408 may be dedicated servers, blade servers, or applications running on a client machine. For example, in some implementations, the servers 408 may be running as a background application on combinations of clients 402 through 406. In some implementations, the servers 408 include a combination of log-in servers and game servers.

Log-in servers can accept connections from clients 402 through 406. For example, as illustrated by communications A₁, A₂, and A₃, clients 402 through 406 can communicate log-in credentials to a log-in server or game server. Once the identity of a game player using any one of the clients has been established, the servers 408 can transmit information corresponding to locations of one or more game servers, session identifiers, and the like. For example, as illustrated by communications B₁, B₂, and B₃, the clients 402 through 406 may receive server names, session IDs and the like which the clients 402 through 406 can use to connect with a game server or game lobby. In some implementations, the log-in server may include information relating to the player corresponding to their log-in credentials. Some examples of player related information include an in-game rank (e.g., No. 5 out 1000 players) or high score, a friends list, billing information, or an in-game mailbox. Moreover, in some implementations, a log-in server can send the player into a game lobby.

The game lobby may allow the player to communicate with other players by way of text chat, voice chat, video chat, or combinations thereof. In addition, the game lobby may list a number of different games that are in progress, waiting on additional players, or allow the player to create a new instance of the game, to name a few examples. Once the player selects a game, the game lobby can transfer control of the player from the game lobby to the game. In some implementations, a game can be managed by more than one server. For example, consider a game with two continents A and B. Continents A and B may be managed by one or more servers 408 as appropriate. In general, the number of servers required for a game environment can be related to the number of game players playing during peak times.

In some implementations, the game world is a persistent game environment. In such implementations, when the player reaches the game lobby, they may be presented with a list of game worlds to join, or they may be allowed to search for a game world based on certain criteria, to name a few examples. If the player selects a game world, the in game lobby can transfer control of the player over to the selected game world.

In some implementations, the player may not have any characters associated with their log-in credentials. In such implementations, the one or more servers can provide the player with various choices directed to creating a character of the player's choice. For example, in an RPG, the player may be presented with choices relating to the gender of the character, the race of the character, and the profession of the character. As another example, in an FPS, the player may be presented with choices relating to the gender of the character, the faction of the character, and the role of the character (e.g., sniper, medic, tank operator, and the like).

Once the player has entered the game, as illustrated by communications C₁, C₂, and C₃, the servers 408 and the respective clients can exchange information. For example, the clients 402 through 406 can send the servers 408 requests corresponding to in-game actions that the players would like to attempt (e.g., shooting at another character or opening a door), movement requests, disconnect requests, or other in-game requests can be sent. In addition, the clients 402 through 406 can transmit images captured by cameras 402a through 406a, respectively. In some implementations, the clients 402 through 406 send the changes to the facial positions as determined by the tracker, instead of sending the entire image capture.

In response, the servers 408 can process the information and transmit information corresponding to the request (e.g., also by way of communications C₁, C₂, and C₃). Information can include resolutions of actions (e.g., the results off shooting another character or opening a door), updated positions for in-game characters, or confirmation that a player wishes to quit, to name a few examples. In addition, the information may include modified in-game representations corresponding to changes in the facial positions of one or more close characters. For example, if client 402 modifies their respective face texture and transmits it to the servers 408 through communication C₁, the servers 408 can transmit the updated facial texture to clients 404 and 406 through communications C₂ and C₃, respectively. The clients 404 and 406 can then apply the face texture to the in-game representation corresponding to client 402 and display the updated representation.

FIG. 4B is a conceptual system diagram 420 showing interactions among components in a multi-player gaming system. This figure is similar to FIG. 4A, but involves more communication in a peer-to-peer mariner between the clients, and less communication between the clients and the one or more servers 426. The server may be eliminated entirely, or as shown here, may assist in coordinating direct communications between the clients.

The system 420 includes clients 422 and 424. Each client can have a camera, such as camera 422a, and 424a, respectively. The clients can communicate through network 428 using TCP/IP, for example. The clients can be connected through a LAN, a WAN or the Internet, to name a few examples. In some implementations, the clients 422 and 424 can send log-in requests A₁ and A₂ to servers 426. The servers 426 can respond with coordination information B₁ and B₂, respectively. The coordination information can include network identifiers such as MAC addresses or IP addresses of clients 422 and 424, for example. Moreover, in some implementations, the coordination information can initiate a connection handshake between clients 422 and 424. This can communicatively couple clients 42 and 424 over network 428. In other words, instead of sending updated images or changes in captured images using communications C₁ and C₂ to servers 426, the communications C₁ and C₂ can be routed to the appropriate client. For example, the clients 422 and 424 can modifying appropriate network packets with the network identifiers transmitted by servers 426 or negotiated between clients 422 and 424 to transmit communications C₁ and C₂ to the correct destination.

In some implementations, the clients 422 and 424 can exchange connection information or otherwise negotiate a connection without communicating with servers 426. For example, clients 422 and 424 can exchange credentials A₁ and A₂ respectively, or can generate anonymous connections. In response the clients 422 and 424 can generate response information B₁ and B₂, respectively. The response information can specify that a connection has been established or the communicate socket to use, to name two examples. Once a connection has been established, clients 422 and 424 can exchange updated facial information or otherwise update their respective in-game representations. For example, client 422 can transmit a change in the position of a mask, and client 424 can update the head of an in-game representation in a corresponding manner. As another example, clients 422 and 424 may exchange updated position information of their respective in-game representations as the characters move around the game environment.

In some implementations, the clients 422 and 424 can modify the rate that they transmit and/or receive image updates based on network latency and/or network bandwidth. For example, pings may be sent to measure the latency, and frame rate updates may be provided based on the measured latency. For example, the higher the network latency, fewer image updates may be sent. Alternatively or in addition, bandwidth may be determined in various known manners, and updates may be set for a game, for a particular session of a game, or may be updated on-the-fly as bandwidth may change. In addition, the clients may take advantage of in-game position to reduce the network traffic. For example, If the in-game representations of clients 422 and 424 are far apart such that their respective in-game cameras would not display changes to facial features (e.g., facial expressions), then the information included in C₁ and C₂, respectively, may include updated position information, and not updated face texture information.

FIG. 5A is a schematic diagram of a system 500 for coordinating multiple users with captured video through a central information coordinator service. A central information coordinator service can receive information from one or more client systems. For example, the information coordinator service 504 can receive information from clients 502 and 506 (i.e., PC1 502, and PC2 506).

The PC1 client 502 includes a webcam 508. The webcam can capture both still images and live video. In some implementations, the webcam 508 can also capture audio. The webcam 508 can communicate with a webcam client 510. In some implementations, the webcam client 510 is distributed along with the webcam. For example, during installation of the webcam, a CD containing webcam client software may also be installed. The webcam client 510 can start and stop the capturing of video and/or audio, transmit capture video and/or audio, and provide a preview of the captured video and/or audio, to name a few examples.

The PC1 client 502 also includes an application, such as ActiveX application 512. The ActiveX application 512 can be used to manage the captured images, generate a mask, track the mask, and communicate with both PC2 506 and the information coordinating service 504. The ActiveX application 512 may include a game presentation and render engine 514, a video chat module 516, a client flash application 518, an object cache 520, a cache manager 522, and an object cache 520. In some implementations, the ActiveX application 512 may be a web browser component that can be automatically downloaded from a website.

Other applications and other approaches may also be used on a client to manage image capture and management. Such applications may be embedded in a web browser or may be part of a standalone application.

The game presentation and render engine 514 can communicate with the webcam client 510 and request captured video frames and audio, for example. In addition, the tracker can communicate with the video chat module 516 and the client flash application 518. For example, the game presentation and render engine 514 can send the audio and video to the video chat module 516. The video chat module 516 can then transmit the capture audio and/or video to PC2 506. In some implementations, the transmission is done in a peer-to-peer manner (i.e., some or all of the communications are processed without the aid of the central information coordinating service 504). In addition, the game presentation and render engine 514 can transmit the captured audio and/or video to the client flash application 518. Moreover, in some implementations, the game presentation and render engine may compute and store the 3D mask, determine changes in position of the 3D in subsequent frames, or recognize a learned face. For example, the game presentation and render engine 514 can communicate with the object cache 520 to store and receive 3D masks. In addition, the game presentation and render engine 514 can receive information from the client flash application 518 through an external application program interface (API). For example, the client flash application 518 can send the tracker a mask that is defined manually by a user of PCl 502. Moreover, the game presentation and render engine 514 can communicate with the object cache 520 (described below).

The client flash application 518 can provide a preview of the captured video and/or audio. For example, the client flash application 518 may include a user interface that is subdivided into two parts. A first part can contain a view area for the face texture, and a second part can contain a view area that previews the outgoing video. In addition, the client flash application 518 may include an ability to define a 3D mask. For example, a user can select a masking option and drag a 3D mask over their face. In addition, the user can resize or rotate the mask as appropriate to generate a proper fit. The client flash application 518 can use various mechanisms to communicate with the game presentation and render engine 514 and can send manually generated 3D masks to the game presentation and render engine 514 for face tracking purposes, for example.

Various approaches other than flash may also be used to present a game and to render a game world, tokens, and avatars. As one example, a standalone program independent of a web browser may using various gaming and graphics engines to perform such processes.

Various caches, such as an object cache 520 and mask cache 524 may be employed to store information on a local client, such as to prevent a need to download every game's assets each time a player launches the game. The object cache 520 can communicate with a cache manager 522 and the game presentation and render engine 514. In communicating with the cache manager 522 and game presentation and render engine 514, the object cache 520 can provide them with information that is used to identify a particular game asset (e.g., a disguise), for example.

The cache manager 522 can communicate with the object cache 520 and the mask cache 524. The mask cache 524 need not be implemented in most situations, where the mask will remain the same during a session, but the mask cache 524 may also optionally be implemented when the particular design of the system warrants it. The cache manager 522 can store and/or retrieve information from both caches 520 and 524, for example. In addition, the cache manager 522 can communicate with the central information coordinator service 504 over a network. For example, the cache manager 522 can transmit a found face through an interface. The central information coordinator service 504 can receive the face, and use a database 534 to determine if the transmitted face matches a previously transmitted face. In addition, the cache manager 522 can receive masks 532 and objects 536 from the central information coordinator service 504. This can allow PC1 502 to learn additional features, ferns, faces, and the like.

The mask cache 524 may store information relating to one or masks. For example, the mask cache may include a current mask, and a mask from one or more previous frames. The game presentation and render engine 514 can query the mask cache 524 and used the stored mask information to determine a change in salient points of the mask, for example.

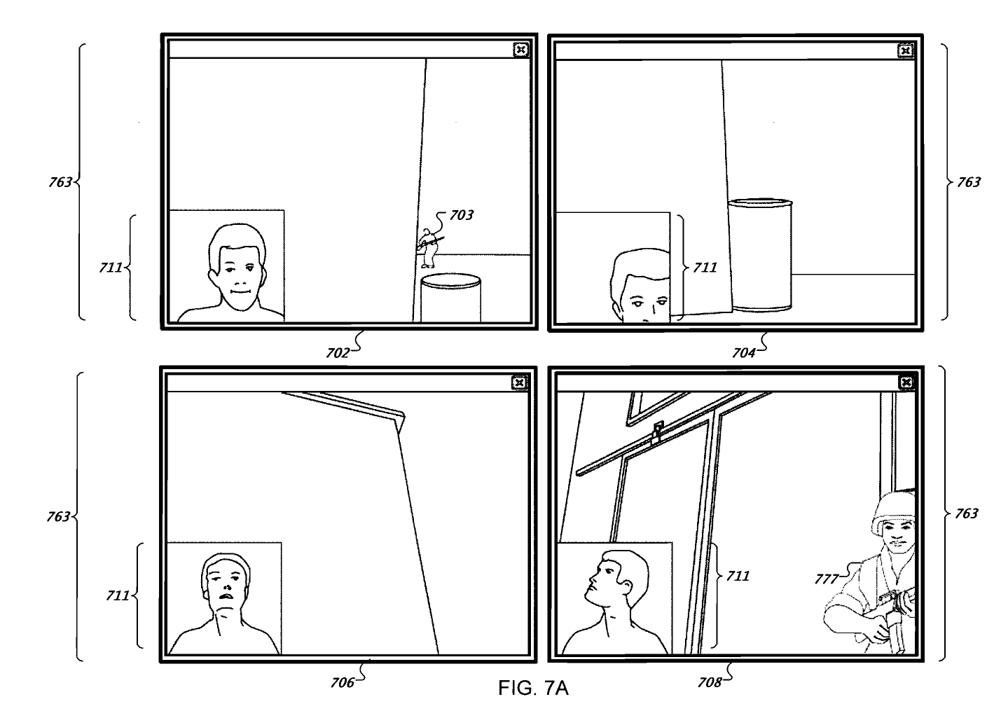

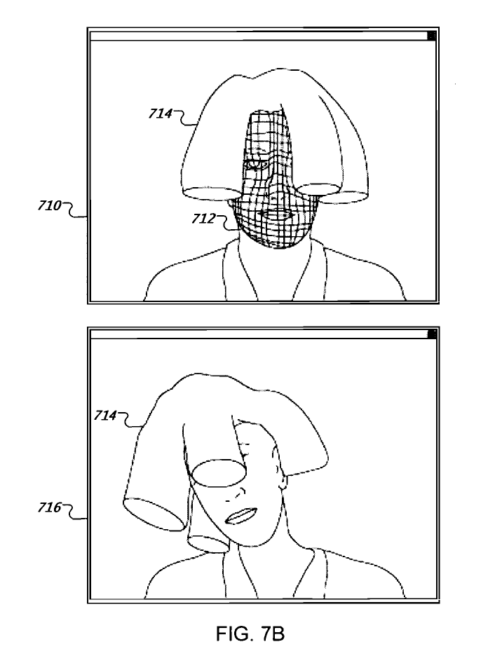

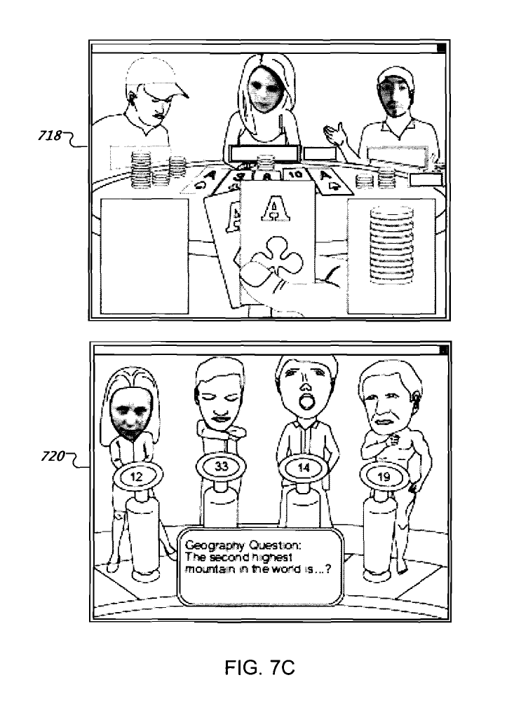

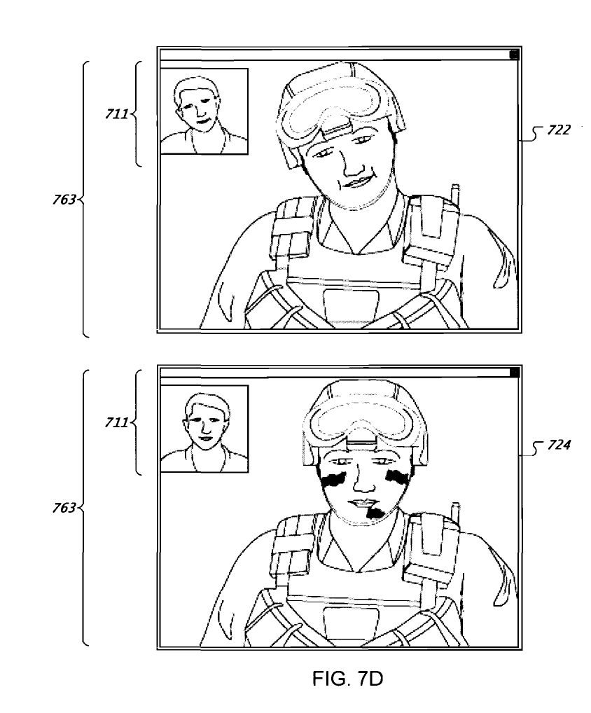

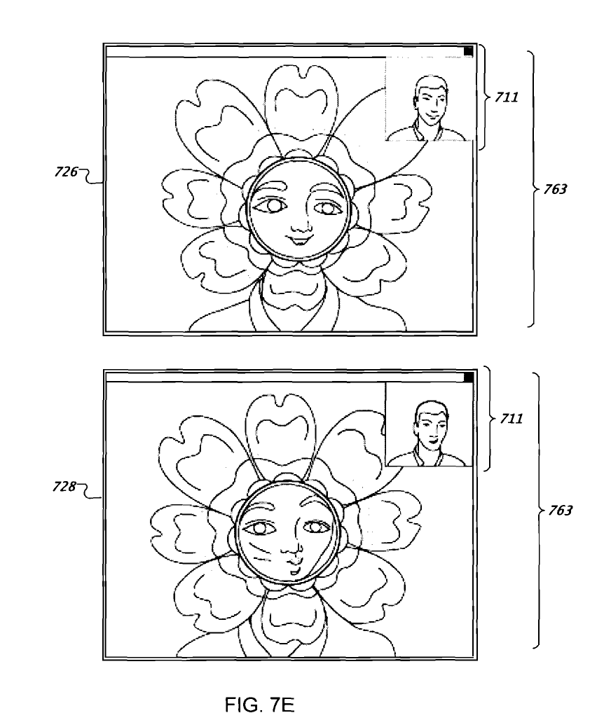

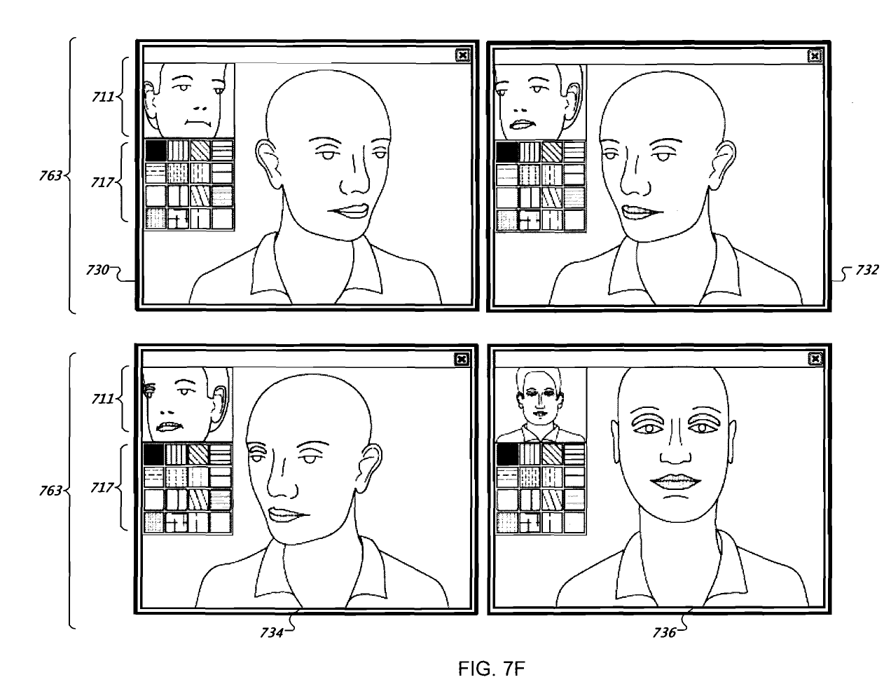

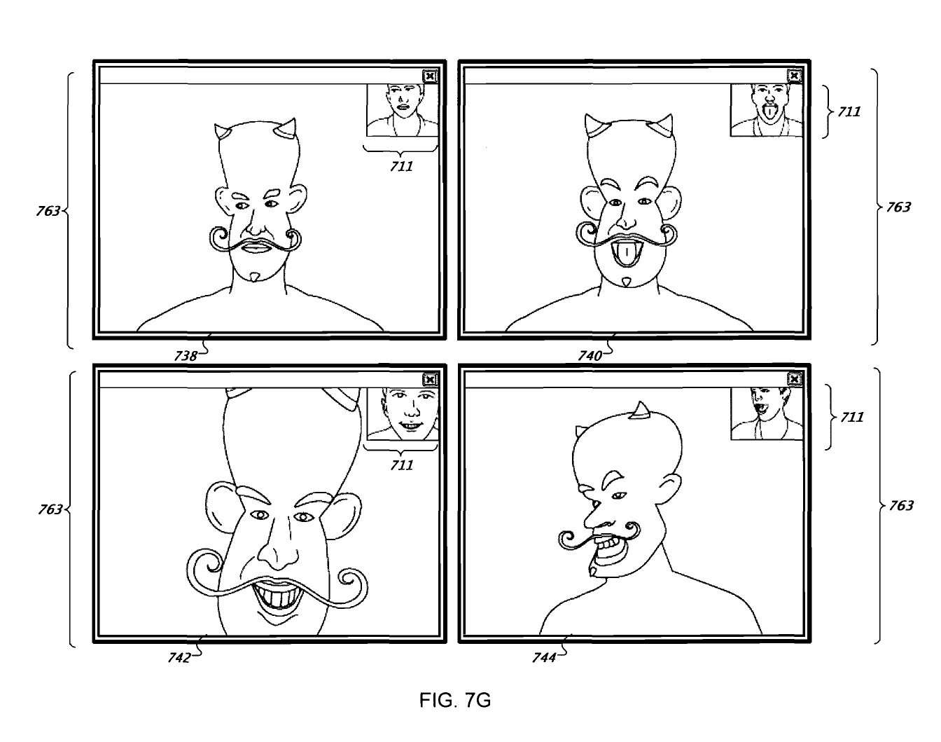

On the server side in this example, various assets are also provided from a server side, such as textures, face shapes, disguise data, and 3D accessories. In addition to including masks 532, a database 534, and objects 536 (e.g., learned features, faces, and ferns), the central information service 504 can also include a gameplay logic module 530. The gameplay logic module 530 may define the changes in gameplay when changes in a mask are received. For example, the gameplay logic module 530 can specify what happens when a user ducks, moves towards the camera, moves away from the camera, turns their head from side to side, or modifies their face texture. Examples of gameplay elements are described in more detail in reference to FIGS. 7A-7G.

In some implementations, PC1 502 and PC2 506 can have substantially similar configurations. For example, PC2 506 may also have an ActiveX application or web browser plug-in that can generate a mask, track the mask, and communicate with both PC1 502 and the information coordinating service 504. In other implementations, client 506 may have a webcam and a capacity for engaging in video chat without the other capabilities described above. This allows PC1 502 to communicate with clients that may or may not have the ability to identify faces and changes to faces in real-time.

FIG. 5B is a schematic diagram of a system 550 for permitting coordinated real time video capture gameplay between players. In general, the system includes two or more gaming devices 558, 560, such as personal computers or videogame consoles that may communicate with each other and with a server system 562 so that users of the gaming devices 558, 560 may have real-time video capture at their respective locations, and may have the captured video transmitted, perhaps in altered or augmented form, to the other gaming device to improve the quality of gameplay.

The server system 562 includes player management servers 552, real-time servers 556, and a network gateway 554. The server system 562 may be operated by one or more gaming companies, and may take a general form of services such as Microsoft's Xbox Live, PLAYSTATION®, Network, and other similar systems. In general, one or more of the servers 554, 556 may be managed by a single organization, or may be split between organizations (e.g., so that one organization handles gamer management for a number of games, but real-time support is provided in a more distributed (e.g., geographically distributed) manner across multiple groups of servers so as to reduce latency effects and to provide for greater bandwidth).

The network gateway 554 may provide for communication functionality between the server system 562 and other components in the larger gaming system 550, such as gaming devices 558, 560. The gateway 554 may provide for a large number of simultaneous connections, and may receive requests from gaming devices 558, 560 under a wide variety of formats and protocols.

The player management servers 552 may store and manage relatively static information in the system 550, such as information relating to player status and player accounts. Verification module 566 may, for example, provide for log in and shopping servers to be accessed by users of the system 550. For example, players initially accessing the system 550 may be directed to the verification module 566 and may be prompted to provide authentication information such as a user name and a password. If proper information is provided, the user's device may be given credentials by which it can identify itself to other components in the system, for access to the various features discussed here. Also, from time to time, a player may seek to purchase certain items in the gaming environment, such as physical items (e.g., T-Shirts, mouse pads, and other merchandise) or non-physical items (e.g., additional games levels, weapons, clothing, and other in-game items) in a conventional manner. In addition, a player may submit captured video items (e.g., the player's face superimposed onto a game character or avatar) and may purchase items customized with such images (e.g., T Shirts or coffee cups).

Client update module 564 may be provided with information to be provided to gaming devices 558, 560, such as patches, bug fixes, upgrades, and updates, among other things. In addition, the updates may include new creation tool modules or new game modules. The client update module 564 may operate automatically to download such information to the gaming devices 558, 560, or may respond to requests from users of gaming devices 558, 560 for such updates.

Player module may manage and store information about players, such as user ID and password information, rights and privilege information, account balances, user profiles, and other such information.

The real-time servers 556 may generally handle in-game requests from the gaming devices 558, 560. For example, gameplay logic 570 may manage and broadcast player states. Such state information may include player position and orientation, player status (e.g., damage status, movement vectors, strength levels, etc.), and other similar information. Game session layer 572 may handle information relevant to a particular session of a game. For example, the game session layer may obtain network addresses for clients in a game and broadcast those addresses to other clients so that the client devices 558, 560 may communicate directly with each other. Also, the game session layer 572 may manage traversal queries.

The servers of the server system 562 may in turn communicate, individually or together, with various gaming devices, 558, 560, which may include personal computers and gaming consoles. In the figure, one such gaming device 558 is shown in detail, while another gaming device 560 is shown more generally, but may be provided with the same or similar detailed components.

The gaming device 560 may include, for example, a web cam 574 (i.e., an inexpensive video camera attached to a network-connected computing device such as a personal computer, a smartphone, or a gaming console) for capturing video at a user's location, such as video that includes an image of the user's face. The web cam 574 may also be provided with a microphone, or a separate microphone may be provided with the gaming device 558, to capture sound from the user's location. The captured video may be fed to a face tracker 576, which may be a processor programmed to identify a face in a video frame and to provide tracking of the face's position and orientation as it moves in successive video frames. The face tracker 576 may operate according to the processes discussed in more detail above.

A 3D engine 578 may receive face tracking information from the face tracker 576, such as position and orientation information, and may apply the image of the face across a 3D structure, such as a user mask. The process of applying the 2D frame image across the mask, known as reverse mapping, may occur by matching relevant points in the image to relevant points in the mask.

A video and voice transport module 582 may manage communications with other gaming devices such as gaming device 560. The video and voice transport module 582 may be provided, for example, with appropriate codecs and a peer-to-peer manager at an appropriate layer. The codecs can be used to reduce the bandwidth of real-time video, e.g., of reverse rendering to unfold a video capture of a user's face onto a texture. The codecs may convert data received about a video image of a player at gaming device 560 into a useable form and pass it on for display, such as display on the face of an avatar of the player, to the user of gaming device 558. In a like manner, the codecs may convert data showing the face of the user of gaming device 558 into a form for communication to gaming device 560. The video and voice transport modules of various gaming devices may, in certain implementations, communicate directly using peer-to-peer techniques. Such techniques may, for example, enable players to be matched up with other players through the server system 562, whereby the server system 562 may provided address information to each of the gaming devices so that the devices can communicate directly with each other.

A game presentation 584 module may be responsible with communicating with the server system 562, obtaining game progress information, and converting the received information for display to a user of gaming device 558. The received information may include heads-up display (HUD) information such as player health information for one or more users, player scores, and other real-time information about the game, such as that generated by the gameplay logic module 570. Such HUD information may be shown to the player over video image so that it looks like a display on the player's helmet screen, or in another similar manner. Other inputs to the game presentation module 584 are scene changes, such as when the background setting of a game changes (e.g., the sun goes down, the players hyperport to another location, etc.). Such change information may be provided to the 3D engine 578 for rendering of a new background area for the gameplay.

The game presentation module 584 may also manage access and status issues for a user. For example, the game presentation module may submit log in requests and purchase requests to the player management servers 552. In addition, the game presentation module 584 may allow players to browse and search player information and conduct other game management functions. In addition, the game presentation module may communicate, for particular instances of a game, with the real-time servers 556, such as to receive a session initiation signal to indicate that a certain session of gameplay is beginning.

A cache 580 or other form of memory may be provide to store various forms of information. For example, the cache 580 may receive update information from the server system 562, and may interoperate with other components to cause the device 558 software or firmware to be updated. In addition, the cache 580 may provide information to the 3D engine 578 (e.g., information about items in a scene of a game) and to the game presentation module 584 (e.g., game script and HUD asset information).

The pictured components in the figure are provided for purposes of illustration. Other components (e.g., persistent storage, input mechanisms such as controllers and keyboards, graphics and audio processors, and the like) would also typically be included with such devices and systems.

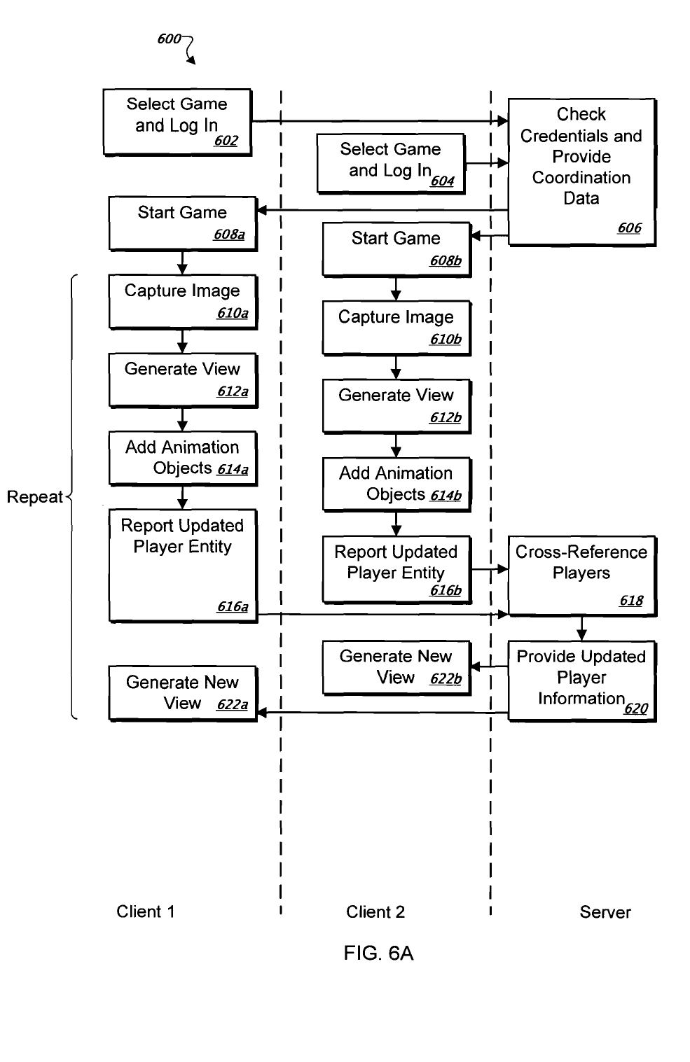

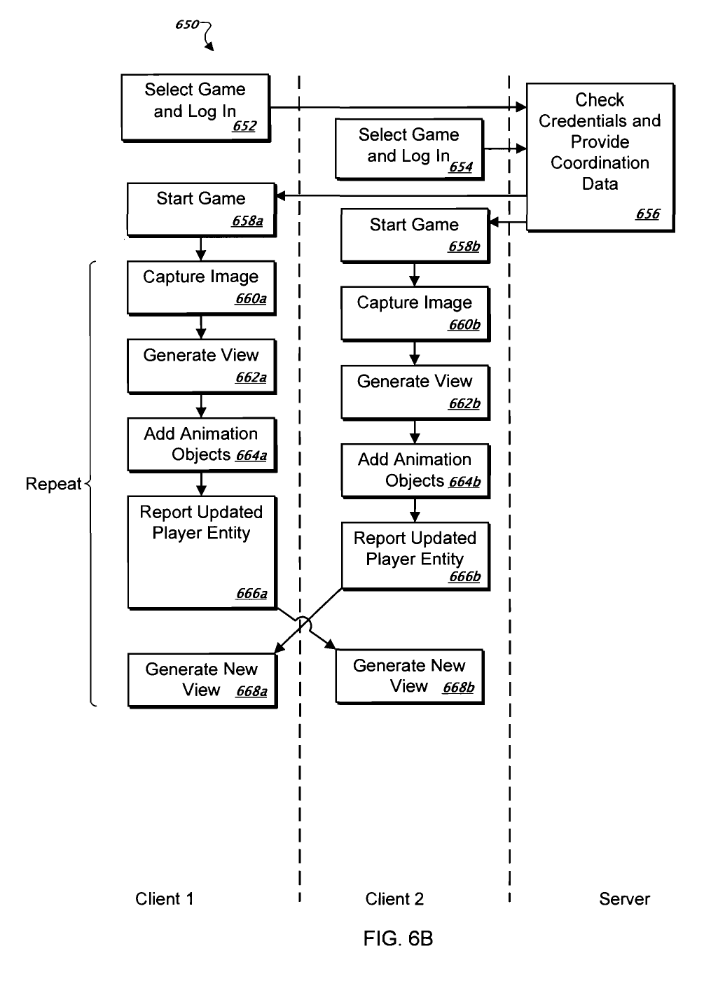

FIGS. 6A and 6B are a swim lane diagrams showing interactions of components in an on-line gaming system. In general, FIG. 6A shows a process centered around interactions between a server and various clients, so that communication from one client to another pass through the server. FIG. 6B shows a process centered around client-to-client interactions, such as in a peer-to-peer arrangement, so that many or all communication in support of a multi-player game do not pass through a central server at all.

FIG. 6A illustrates an example client server interaction 600. Referring to FIG. 6A, in step 602, a first player can select a game and log in. For example, the first player can put game media into a drive and start a game or the first player can select an icon representing a game from a computer desktop. In some implementations, logging in may be accomplished through typing a user name and password, or it may be accomplished through submitting a captured image of the first player's face. In step 604, a second player can also select a game and log in a similar manner as described above.

In step 606, one ore more servers can receive log-in credentials, check the credentials, and provide coordination data. For example, one or more servers can receive images of faces, compare them to a known face database, and send the validated players a server name or session ID.

In steps 608a and 608b, the game starts. In steps 610a and 610b, cameras connected with the first and second player's computers can capture images. In some implementations, faces can be extracted from the captured images. For example, classifiers can be applied to the captured image to find one or more faces contained therein.

In steps 610a and 610b, the clients can capture an image of a face. For example, a webcam can be used to capture video. The video can be divided into frames, and a face extracted from a first frame of the captured video.

In steps 612a and 612b, a camera view can be generated. For example, an in-game environment can be generated and the camera view can specify the portion of the game environment that the players can view. In general, this view can be constructed by rendering in-game objects and applying appropriate textures to the rendered objects. In some implementations, the camera can be positioned in a first person perspective, a top down perspective, or an over the shoulder perspective, to name a few examples.

In steps 614a and 614b, animation objects can be added. For example, the players may choose to add an animate-able appendage, hair, or other animate-able objects to their respective in-game representations. In some implementations, the animate-able appendages can be associated with one or more points of the face. For example, dreadlocks can “attached” to the top of the head. Moreover, the animate-able appendages can be animating using the motion of the face and appropriate physics properties. For example, the motion of the face can be measured and sent to a physics module in the form of a vector. The physics module can receive the vector and determine an appropriate amount of force that is applied to the appendage. Moreover, the physics module can apply physical forces (e.g., acceleration, friction, and the like) to the appendage to generate a set of animation frames for the appendage. As one example, if the head is seen to move quickly downward, the dreadlocks in one example may fly up and away from the head and then fall back down around the head.

In steps 616a and 616b, the clients can send an updated player entity report to the servers. The clients can transmit changes in their respective representations to the servers. For example, the clients can transmit updates to the face texture or changes to the mask pose. As another example, the clients can transmit the added animation objects to the servers. As another example, the clients can transmit requests relating to in-game actions to servers. Actions may include, firing a weapon at a target, selecting a different weapon, and moving an in-game, to name a few examples. In some implementations, the clients can send an identifier that can be used to uniquely identify the player. For example, a globally unique identifier (GUID) can be used to identify a player.

In step 618, the servers can receive updated player information and cross-reference the players. For example, the servers can receive updated mask positions or facial features, and cross-reference the facial information to identify the respective players. In some implementations, the servers can receive an identifier that can be used to identify the player. For example, a GLIID can be used to access a data structure containing a list of players. Once the player has been identified, the servers can apply the updates to the player information. In some implementations, in-game actions may harm the player. In such implementations, the servers may also verify that the in-game character is still alive, for example.

In step 620, the server can provide updated player information to the clients. For example, the server can provide update position information, updated poses, update faces textures and/or changes in character state (e.g., alive, dead, poisoned, confused, blind, unconscious, and the like) to the clients. In some implementations, if the servers determine that substantially few changes have occurred, then the servers may avoid transferring information to the clients (e.g., because the client information may be currently up to date).

In steps 622a and 622b, the clients can generate new in-game views corresponding to the information received from the servers. For example, the clients can display an updated character location, character state, or character pose. In addition, the view can be modified based on a position of the player's face in relation to the camera. For example, if the player moves their head closer to the camera the view may be zoomed-in. As another example, if the player moves their head farther from the camera, the view may be zoomed-out.

Steps 610a, 610b, 612a, 612b, 614a, 614b, 616a, 616b, 618, 620, 622a, and 622b may be repeated as often as is necessary. For example, a typical game may generate between 30 and 60 frames per second and these steps may be repeated for each frame generated by the game. For this and other reasons, the real-time capture system described can be used during these frame-rate updates because it is capable of processing the motion of faces in captured video at a substantially similar rate.

FIG. 6B illustrates an example peer-to-peer interaction 650. This figure is similar to FIG. 6A, but involves more communication in a peer-to-peer manner between the clients, and less communication between the clients and the one or more servers. For example, steps 652, 654, 656, 658a through 664a, and 658b through 664b are substantially similar to their steps 602, 604, 606, 608a through 614a and 608b through 616b, respectively. In some implementations, the servers may be eliminated entirely, or as shown here, may assist in coordinating direct communications between the clients.

In steps 666a and 666b, the clients can report updated player information to each other. For example, instead of sending an updated player pose to the servers, the client can exchange updated player poses. As another example, instead of sending an updated player position to the servers, the clients can exchange player positions.

In steps 668a and 668b, the clients can generate new camera views in a similar manner to steps 622a and 622b, respectively. However, in steps 668a and 668b, the information that is received and used to generate the new camera views may correspond to information received from the other client.

FIGS. 7A-7G show displays from example applications of a live-action video capture system. FIG. 7A illustrates an example of an FPS game. In each frame, a portion 711 of the frame illustrates a representation of a player corresponding to their relative position and orientation in relation to a camera. For example, in frame 702, the player is centered in the middle of the camera. In each frame, the remaining portion 763 of the frame illustrates an in-game representation. For example, in frame 702, the player can see another character 703 in the distance, a barrel, and a side of a building.

In frame 704, the player ducks and moves to the right. In response, a mask corresponding to the player's face moves in a similar manner. This can cause the camera to move. For example, the camera moves down and to the right which changes what the player can view. In addition, because the player has essentially ducked behind the barrel, character 703 does not have line of sight to the character and may not be able to attack the player.

In frame 706, the player returns to the centered position and orients his head towards the ceiling. In response, the mask rotates in similar manner, and the camera position is modified to match the rotation of the mask. This allows the player to see additional areas of the game world, for example.

In frame 708, the player turns his head to left, exposing another representation of a character 777. In some implementations, the character can represent a player character (i.e., a character who is controlled by another human player) or the character can represent a non-player character (i.e., a character who is controlled by artificial intelligence), to name two examples.

FIG. 7B illustrates a scenario where geometry is added and animated to a facial representation. In frame 710, a mesh 712 is applied to a face. This mesh can be used to manually locate the face in subsequent image captures. In addition some dreadlocks 714 have been added to the image. In some implementations, a player can select from a list of predefined objects that can be applied to the captured images. For example, the player can add hair, glasses, hats, or novelty objects such as a clown nose, to the captured images.

In frame 716, as the face moves, the dreadlocks move. For example, this can be accomplished by tracking the movements of the mask and applying those movements to the dreadlocks 714. In some implementations, gravity and other physical forces (e.g., friction, acceleration, and the like) can also be applied to the dreadlocks 714 to yield a more realistic appearance to their motion. Moreover, because the dreadlocks may move independently of the face the dreadlocks 714 can collide with the face. In some implementations, collisions can be handled by placing those elements behind the face texture. For example, traditional 3-dimensional collision detection can be used (e.g., back-face culling), and 3D objects that are behind other 3D objects can be ignored (e.g., not drawn) in the image frame.

FIG. 7C illustrates an example of other games that can be implemented with captured video. In frame 718, a poker game is illustrated. One or more faces can be added corresponding to the different players in the game. In this way, players can attempt to read a player's response to his cards which can improve the realism of the poker playing experience. In frame 720, a quiz game is illustrated. By adding the facial expressions to the quiz game, player reactions to answer correctly or incorrectly can also add a sense of excitement to the game playing experience.

Other similar multiplayer party games may also be executed using the techniques discussed here. For example, as discussed above, various forms of video karaoke may be played. For example, an Actor's Studio game may initially allow players to select a scene from a movie that they would like to play and then to apply make-up to match the game (e.g., to permit a smoothly blended look between the area around an actor's face, and the player's inserted or overlaid face). The player may also choose to blend elements of the actor's face with his or her own face so that his or her face stands out more or less. Such blending may permit viewers to determine how closely the player approximated the expressions of the original actor when playing the scene. A player may then read a story board about a scene, study lines from the scene (which may also be provided below the scene as it plays, bouncy-ball style), and to watch the actual scene for motivation. The player may then act out the scene. Various other players, or “directors,” may watch the scene, where the player's face is superimposed over the rest of the movie's scene, and may rank the performance. Such review of the performance may happen in real time or may be of a video clip made of the performance and, for example, posted on a social web site (e.g., YouTube) for review and critique by others.

Various clips may be selected in a game that are archetypal for a film genre, and actors may choose to submit their performances for further review. In this way, a player may develop a full acting career, and the game may even involve the provision of awards such as Oscar awards to players. Alternatively, players may substitute new lines and facial actions in movies, such as to create humorous spoofs of the original movies. Such a game may be used, for example, as part of an expressive party game in which a range of friends can try their hands at virtual acting. In addition, such an implementation may be used with music, and in particular implementations with musical movies, where players can both act and sing.

FIG. 7D illustrates an example of manipulating an in-game representation with player movements. The representation in frames 722 and 724 is a character model that may be added to the game. In addition to the predefined animation information, the character model can be modified by the movements of the player's head. For example, in frame 722, the model's head moves in a substantially similar manner to the player's head. In some implementations, characteristics of the original model may be applied to the face texture. For example, in frame 724, some camouflage paint can be applied to the model, even though the player has not applied any camouflage paint directly to his face.

FIG. 7E illustrates another example of manipulating an in-game representation with a player's facial expressions. In frames 726 and 728, a flower geometry is applied to the head region of the player. In addition, the player's face texture is applied to the center of the flower geometry. In frame 726, the player has a substantially normal or at rest facial expression. In frame 728, the player makes a face by moving his mouth to the right. As illustrated by the in-game representation, the face texture applied to the in-game representations can change in a similar manner.

FIG. 7F illustrates an example of manipulating a face texture to modify an in-game representation. In the illustrated example, a color palette 717 is displayed along with the face texture and a corresponding representation. In frame 730, the face texture has not been modified. In frame 732, a color has been applied to the lips of the face texture. As illustrated by the example, this can also modify the in-game representation. In frame 734, the player is moving his head from side to side in an attempt to get a better view of areas of the face texture. He then applies a color on his eye lids. As illustrated by the example, this also can modify the in-game representation. In frame 736, the player's head is centered, and the color can be viewed. For example, the eyes and mouth are colored in the face texture, which modifies the in-game representation to reflect changes in the face texture.

The modifications may be applied on a live facial representation. In particular, because the facial position and orientation is being tracked, the facial location of particular contact between an application tool and the face may be computed. As a result, application may be performed by moving the applicator, by moving the face, or a combination of the two. Thus, for instance, lipstick may be applied by first puckering the lips to present them more appropriately to the applicator, and then by panning the head back and forth past the applicator.

Upon making such modifications or similar modifications (e.g., placing camouflage over a face, putting glasses on a face, stretching portions of a face to distort the face), the modified face may then be applied to an avatar for a game. Also, subsequent frames of the user's face that are captured may also exhibit the same or similar modifications. In this manner, for example, a game may permit a player to enter a facial configuration room to define a character, and then allow the player to play a game with the modified features being applied to the player's moving face in real time.

FIG. 7G illustrates an example of modifying an in-game representation of a non-human character model. For example, in frame 738, the player looks to the left with his eyes. This change can be applied using the face texture and applying it to the non-human geometry using a traditional texture mapping approach. As another example, in frame 740, a facial expression is captured and applied to the in-game representation. For example, the facial expression can be used to modify the face texture and applied to the geometry. As another example, in frame 742, the player moves his head closer to the camera, and in response, the camera zooms in on the in-game representation. As another example, in frame 744, the character turns his head to the left and changes his facial expression. The rotation can cause a change in the position of the salient points in the mask. This change can be applied to the non-human geometry to turn the head. In addition, the modified face texture can be applied to the rotated non-human geometry to apply the facial expression. In each of the frames 738-744, the hue of the facial texture (which can be obtained by reverse rendering) has been changed to red, to reflect a satan-like appearance.

Other example implementations include, but are not limited to, overlaying a texture on a movie, and replacing a face texture with a cached portion of the room. When the face texture is applied to a face in a movie, it may allow a user the ability to change the facial expressions of the actors. This approach can be used to parody a work, as the setting and basic events remain the same, but the dialog and facial expressions can be changed by the user.

In implementations where a cached portion of the room replaces the face texture, this can give an appearance that the users head is missing. For example, when the user starts a session (e.g., a chat session), he can select a background image for the chat session. Then, the user can manually fit a mask to their face, or the system can automatically recognize the user's face, to name two examples. Once a facial texture has been generated, the session can replace the texture with a portion of the background image that corresponds to a substantially similar position relative to the 3D mask. In other words, as the user moves their head and the position of the mask changes, the area of the background that can be used to replace the face texture may also change. This approach allows for some interesting special effects. For example, a user can make objects disappear by moving the objects behind their head. Instead of seeing the objects, witness may view the background image textured to the mask, for example.

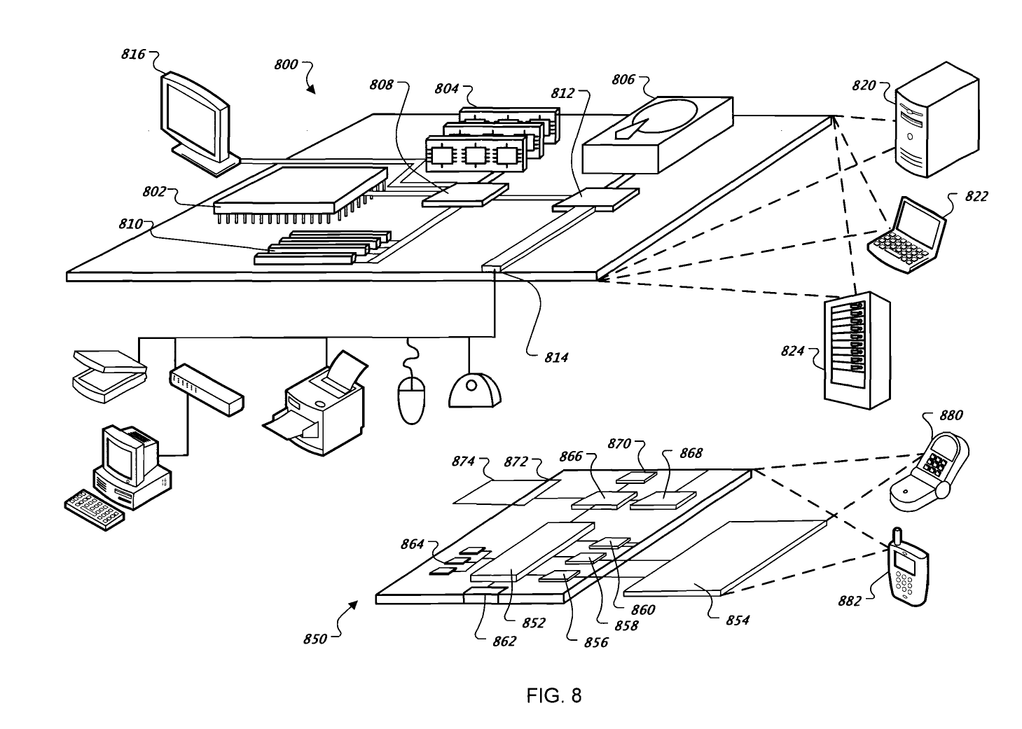

FIG. 8 is a block diagram of computing devices 800, 850 that may be used to implement the systems and methods described in this document, as either a client or as a server or plurality of servers. Computing device 800 is intended to represent various forms of digital computers, such as laptops, desktops, workstations, personal digital assistants, servers, blade servers, mainframes, and other appropriate computers. Computing device 850 is intended to represent various forms of mobile devices, such as personal digital assistants, cellular telephones, smartphones, and other similar computing devices. The components shown here, their connections and relationships, and their functions, are meant to be exemplary only, and are not meant to limit implementations described and/or claimed in this document.

Computing device 800 includes a processor 802, memory 804, a storage device 806, a high-speed interface 808 connecting to memory 804 and high-speed expansion ports 810, and a low speed interface 812 connecting to low speed bus 814 and storage device 806. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high speed interface 808. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 804 stores information within the computing device 800. In one implementation, the memory 804 is a computer-readable medium. In one implementation, the memory 804 is a volatile memory unit or units. In another implementation, the memory 804 is a non-volatile memory unit or units.

The storage device 806 is capable of providing mass storage for the computing device 800. In one implementation, the storage device 806 is a computer-readable medium. In various different implementations, the storage device 806 may be a floppy disk device, a hard disk device, an optical disk device, or a tape device, a flash memory or other similar solid-state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 804, the storage device 806, memory on processor 802, or a propagated signal.

The high-speed controller 808 manages bandwidth-intensive operations for the computing device 800, while the low speed controller 812 manages lower bandwidth-intensive operations. Such allocation of duties is exemplary only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB, Bluetooth, Ethernet, wireless Ethernet), may be coupled to one or more input/output devices, such as a keyboard, a pointing device, a scanner, a networking device such as a switch or router, e.g., through a network adapter, or a web cam or similar image or video capture device.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device (not shown), such as device 850. Each of such devices may contain one or more of computing device 800, 850, and an entire system may be made up of multiple computing devices 800, 850 communicating with each other.

Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 can process instructions for execution within the computing device 850, including instructions stored in the memory 864. The processor may also include separate analog and digital processors. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT LCD display or an OLED display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may be provided in communication with processor 852, so as to enable near area communication of device 850 with other devices. External interface 862 may provide, for example, for wired communication (e.g., via a docking procedure) or for wireless communication (e.g., via Bluetooth or other such technologies).

The memory 864 stores information within the computing device 850. In one implementation, the memory 864 is a computer-readable medium. In one implementation, the memory 864 is a volatile memory unit or units. In another implementation, the memory 864 is a non-volatile memory unit or units. Expansion memory 874 may also be provided and connected to device 850 through expansion interface 872, which may include, for example, a SIMM card interface. Such expansion memory 874 may provide extra storage space for device 850, or may also store applications or other information for device 850. Specifically, expansion memory 874 may include instructions to carry out or supplement the processes described above, and may include secure information also. Thus, for example, expansion memory 874 may be provided as a security module for device 850, and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 874, memory on processor 852, or a propagated signal.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a Bluetooth, WiFi, or other such transceiver (not shown). In addition, GPS receiver module 870 may provide additional wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker, e.g., in a handset of device 850. Such sound may include sound from voice telephone calls, may include recorded sound (e.g., voice messages, music files, etc.) and may also include sound generated by applications operating on device 850.

The computing device 850 may be implemented in a number of different forms, as shown in the figure. For example, it may be implemented as a cellular telephone 880. It may also be implemented as part of a smartphone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other categories of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Embodiments may be implemented, at least in part, in hardware or software or in any combination thereof. Hardware may include, for example, analog, digital or mixed-signal circuitry, including discrete components, integrated circuits (ICs), or application-specific ICs (ASICs). Embodiments may also be implemented, in whole or in part, in software or firmware, which may cooperate with hardware. Processors for executing instructions may retrieve instructions from a data storage medium, such as EPROM, EEPROM, NVRAM, ROM, RAM, a CD-ROM, a HDD, and the like. Computer program products may include storage media that contain program instructions for implementing embodiments described herein.

A number of implementations have been described. Nevertheless, it will be understood that various modifications may be made without departing from the spirit and scope of this disclosure. Accordingly, other implementations are within the scope of the claims.

What is claimed is:

1. A corriputer-implemented video capture process, comprising:
identifying and tracking a face in a plurality of real-time video frames on a first computing device;
generating first face data representative of the identified and tracked face; and
transmitting the first face data to a second computing device over a network for display of the face on an avatar body by the second computing device in real time.

2. The method of claim 1, wherein tracking the face comprises identifying a position and orientation of the face in successive video frames.

3. The method of claim 1, wherein tracking the face comprises identifying a plurality of salient points on the face and tracking frame-to-frame changes in positions of the salient points.

4. The method of claim 3, further comprising identifying changes in spacing between the salient points and recognizing the changes in space as forward or backward movement by the face.

5. The method of claim 1, further comprising generating animated objects and moving the animated objects with tracked motion of the face.

6. The method of claim 1, further comprising changing a first-person view displayed by the first computing device based on motion by the face.

7. The method of claim 1, wherein the first face data comprises position and orientation data.

8. The method of claim 1, wherein the first face data comprises three-dimensional points for a facial mask and image data from the video frames to be combined with the facial mask.

9. The method of claim 1, further comprising receiving second face data from the second computing device and displaying with the first computing device video information for the second face data in real time on an avatar body.

10. The method of claim 9, further comprising displaying on the first computing device video information for the first face data simultaneously with displaying with the first computing device video information for the second face data.

11. The method of claim 9, wherein transmission of face data between the computing devices is conducted in a peer-to-peer arrangement.

12. The method of claim 11, further comprising receiving from a central server system game status information and displaying the game status information with the first computing device.

13. A recordable-medium having recorded thereon instructions, which when performed, cause a computing device to perform actions comprising:
identifying and tracking a face in a plurality of real-time video frames on a first computing device;
generating first face data representative of the identified and tracked face; and
transmitting the first face data to a second computing device over a network for display of the face on an avatar body by the second computing device.

14. The recordable medium of claim 13, wherein tracking the face comprises identifying a plurality of salient points on the face and tracking frame-to-frame changes in positions of the salient points.

15. The recordable medium of claim 14, wherein the medium further comprises instructions that when executed receive second face data from the second computing device and display with the first computing device video information for the second face data in real time on an avatar body.

16. A computer-implemented video game system, comprising:
a web cam connected to a first corriputing device and positioned to obtain video frame data of a face;
a face tracker to locate a first face in the video frame data and track the first face as it moves in successive video frames; and
a processor executing a game presentation module to cause generation of video for a second face from a remote computing device in near real time by the first computing device.

17. The system of claim 16, wherein the face tracker is programmed to trim the first face from the successive video frames and to block the transmission of non-face video information.

18. The system of claim 16, further comprising a codec configured to encode video frame data for the first face for transmission to the remote computing device, and to decode video frame data for the second face received from the remote computing device.

19. The system of claim 18, further comprising a peer-to-peer application manager for routing the video frame data between the first computing device and the remote computing device.

20. The system of claim 16, further comprising an engine to correlate video data for the first face with a three-dimensional mask associated with the first face.

21. The system of claim 16, further comprising a plurality of real-time servers configured to provide game status information to the first computing device and the remote computing device.

22. The system of claim 16, wherein the game presentation module receives game status information from a remote coordinating server and generates data for a graphical representation of the game status information for display with the video of the second face.

23. A computer-implemented video game system, comprising:
a web cam positioned to obtain video frame data of a face; and
means for tracking the face in successive frames as the face moves and for providing data of the tracked face for use by a remote device.
